(19) United States
(12) Patent Application Publication
(10) Pub. No.: US 2015/0362728 A1
(43) Pub. Date: Dec. 17, 2015

(54) SEMITRANSPARENT DIFFUSION-POLARIZATION LAMINATE AND USAGE THEREFOR

(71) Applicant: DAICEL CORPORATION, Osaka-shi, Osaka (JP)

(72) Inventor: Takahiro TEI, Tokyo (JP)

(73) Assignee: DAICEL CORPORATION, Osaka-shi, Osaka (JP)

(21) Appl. No.: 14/761,418

(22) PCT Filed: Jan. 8, 2014
(86) PCT No.: PCT/JP2014/050123

§ 371 Date: Jul. 16, 2015

(30) Foreign Application Priority Data
Jan. 17, 2013 (JP) 2013-006442
Mar. 6, 2013 (JP) 2013-044613
Sep. 2, 2013 (JP) 2013-181531

(51) Int. Cl. G02B 27/01; G02B 27/28; G03B 21/604; G02B 5/30

(52) U.S. Cl. CPC G02B 27/0101; G02B 5/305; G02B 27/286; G02B 27/283; G03B 21/604; G02B 2027/0118; G02B 2027/0194; G02B 2027/0196

(57) ABSTRACT

Provided is a polarization laminate that allows a distinct transmission image to be displayed on a translucent screen while maintaining the visibility of a projection image from a projector even in a case where the translucent screen contains a diffusion-polarization plate. A transparent polarization laminate as a member of a translucent projector screen for displaying a projection image from a projector comprises a diffusion polarization layer and an absorption polarization layer, the diffusion polarization layer comprises a continuous phase comprising a first transparent thermoplastic resin and a dispersed phase comprising a second transparent thermoplastic resin and having a refractive index different from that of the continuous phase, and these layers are laminated so that the diffusion polarization layer may have a transmission axis substantially parallel with a transmission axis of the absorption polarization layer. The diffusion polarization layer may comprise a stretched sheet, the continuous phase may have an in-plane birefringence of less than 0.05, the dispersed phase may have an in-plane birefringence of not more than 0.05, and a difference in refractive index for linearly polarized light between the continuous phase and the dispersed phase in a stretching direction may be different from that in a direction perpendicular to the stretching direction.

### TECHNICAL FIELD

The present invention relates to diffusion-polarization laminates for translucent screens of head mounted displays or window displays, translucent (semi-transmissive) projector screens comprising the laminates, and projection systems comprising the screens. The present invention also relates to methods for improving the visibility of projection images and transmission images.

### BACKGROUND ART

Translucent screens (semi-transmissive screens or transparent reflective or transmissive screens) can display a projection image from a projector and allows visual recognition of the other side of the screen. A translucent screen is being used for a window display, a head up display (HUD), a head mounted display (HMD), and others. As the translucent screen (transparent projection screen), for example, a hologram screen and a half-mirror screen are known. Unfortunately, the hologram screen cannot discriminate a natural light from an artificial light (polarized light) due to no polarization selectivity, and it is difficult to clearly display an image under a bright natural light. The half-mirror screen unavoidably has a structural shortcoming of obstructing part of the field of view, and in principle, the half-mirror screen is difficult to increase in size. As the translucent screen, a screen having a diffusion-polarization plate is also known.

Japanese Patent Application Laid-Open Publication No. 2006-227581 (JP-2006-227581A, Patent Document 1) discloses a transmitting-reflecting projection screen for displaying images on its both sides by reflecting and transmitting imaging light projected; the screen comprises a reflective (reflection-type) screen that reflects a specific polarized component of imaging light projected, and a transmissive (transmission-type) screen that transmits a polarized component of the imaging light having passed through the reflective screen without being reflected, the polarized component being different from the specific polarized component. This document discloses a polarized-light selective reflection layer made of a polarized-light-separating film having a cholesteric liquid-crystal structure as the reflective screen, and a rear-side diffraction layer formed with a transmissive volume hologram as the transmissive screen. Further, the document discloses that, by placing an absorption polarizer between the reflective screen and the transmissive screen, it becomes possible to more certainly separate two types of polarized light that the projection screen reflects and transmits, wherein the absorption polarizer absorbs a specific polarized component to be reflected on the reflective screen.

Japanese Patent Application Laid-Open Publication No. 2007-219258 (JP-2007-219258A, Patent Document 2) discloses a projection screen comprising a first transparent screen and a second screen disposed at a backside of the first transparent screen. To a light containing a first polarized light component and a second polarized light component, the first transparent screen diffuses and reflects a light having the first polarized light component and transmits other light, the second screen diffuses and reflects the light that transmitted the first transparent screen, and the first transparent screen and the second screen are disposed apart from each other. This document discloses a polarized light selective reflection layer consisting of a liquid-crystal composition having a cholesteric regularity as the first transparent screen, and discloses that use of a transparent material as the second screen as with the first transparent screen allows the other side of the screen to be seen through. This document also describes that, in a case where the first transparent screen has an insufficient polarized-light-separating function, a polarized light that passed through the first transparent screen can be cut off completely by providing an absorption polarization layer that absorbs and cuts off a light having the first polarized light component and disposing the absorption polarization layer between the first transparent screen and the second screen.

However, these documents only disclose improvement of a polarized-light-separating function of the polarized-light selective reflection layer as the role of the absorption polarizer and fail to disclose the relation between the screen and an outside light (e.g., a natural light) from the other side of the polarizer. In particular, the purpose of the screen described in Patent Document 1 is to see (or visually recognize) a projection image on both sides of the screen (the side at which the projector is disposed and the side at which the projector is not disposed). The document is silent on the visibility of a view through the screen (such as an outdoor or indoor view).

Further, the polarized-light-separating film having a cholesteric liquid-crystal structure has a large dependence on an angle of incidence and varies a reflect ion intensity or a color reproduction according to the angle of incidence. Thus, in a case where a light enters at a wide angle from a projector (in a case where an angle of incidence is large), the reflective screen has a reduced front luminance and cannot display a distinct image. For that reason, the reflective screen is unsuitable for an application in which a light enters at a large angle of incidence from a projector to the screen (for example, a short throw projector, such as HMD). Meanwhile, for the transmissive screen, a display image is whitish and has a low distinctness. In addition, since it is impossible to enter a light at a wide angle of incidence, a light source of the projector is easily reflected in the screen. Moreover, for the combination of a polarized-light-separating film having a cholesteric liquid-crystal structure as a circularly polarizing plate and an absorption polarizer as a linearly polarizing plate, it is necessary to dispose an optical retardation plate (or a phase plate) in the screen.

Japanese Patent Application Laid-Open Publication No. 2010-231080 (JP-2010-231080A, Patent Document 3) discloses a screen comprising a polarizable diffusion film, wherein the polarizable diffusion film is a uniaxially stretched resin film, the uniaxially stretched resin film has a transmission haze to visible light of 15 to 90%, the uniaxially stretched resin film consists of one species of a crystalline resin having an intrinsic birefringence of not less than 0.1, the uniaxially stretched resin film has a crystallinity of 8 to 30%, and an islands-in-the-sea structure is observed in a cut surface perpendicular to a stretching direction of the uniaxially stretched resin film. This document discloses that a polarizable pigment layer is disposed so as to make an absorption axis of the pigment layer substantially intersect perpendicularly to a stretch axis of the polarizable diffusion film and thus the pigment layer can efficiently absorb and remove a polarized light (a polarized light that does not contribute to an image) perpendicular to the stretch axis of the polarizable diffusion film and can increase a contrast in a light place. The document also discloses that a transparent reflective screen is preferably free from a pigment layer and a polarizing plate in order to secure the transparency. The document further discloses that the islands-in-the-sea structure of the uniaxially stretched resin film in composed of an island-shaped light portion having a relatively high crystallinity and a dark portion having a relatively low crystallinity.

However, this document discloses that a translucent screen (transparent reflective or transmissive screen) preferably does not have a pigment layer or a polarizing plate, and there is no description about the relation between the outside light and the pigment layer or the polarizing plate in the translucent screen. Moreover, since the polarizable diffusion film has an islands-in-the-sea structure formed according to a difference in crystallinity of a single crystalline resin, it is difficult to control a refractive index of the film and to improve scattering characteristics or polarization characteristics. Thus, it is difficult to apply the polarizable diffusion film to the translucent screen.

A projector is a device for magnifying and projecting an image on a screen. The visibility of an image displayed on a translucent screen also depends on an ambient illuminance (illuminance of a natural light or an artificial light). Thus, the visibility can be regulated to some degree by adjusting an illuminance (luminance) of a light source of a projector according to the ambient illuminance, although there are some cases where the visibility cannot be improved by regulation of the illuminance of the light source of the projector alone according to the ambient illuminance (in particular, an outside light, such as the sunlight having a high illuminance). Moreover, an increase in the illuminance of the light source of the projector is economically and environmentally inefficient due to increased electricity consumption thereof. In particular, for the translucent screen, it is structurally difficult to be compatible with the visibility of a transmission image (a view of the other side of the screen with respect to an observer, an outdoor or indoor view) and the visibility of an image projected on the screen (a projection image). In a case where there is a large difference in illuminance (light intensity) between the inside and outside of a room, both visibilities are particularly difficult to be compatible. For example, when the translucent screen is used for a window of a vehicle (e.g., an automobile), an exterior window of a building, or others and the sunlight, having a large light intensity, as an outside light enters the window; it is difficult for an observer to see (or visually recognize) a projection image distinctly.

Specifically, the projection screens described in Patent Documents 1 to 3 cannot adjust the outside light intensity. For that reason, in a case where there is a large difference in illuminance between the inside and outside of a room, it is impossible to distinctly see both the projection image and the view (or scenery) of the other side through the screen. In particular, for a projector disposed in a room and a reflective translucent screen, too large an outside light intensity inhibits the improvement of the visibility of a projection image even in a case where the light intensity of the projector is increased.

As a method for adjusting an illuminance of an outside light entering a window of a vehicle (e.g., an automobile), Japanese Patent Application Laid-Open Publication No. 9-300516 (JP-9-300516A, Patent Document 4) discloses a shading film for a vehicle; the shading film comprises a photochromic layer and transparent resin layers provided on both sides of the photochromic layer.

Unfortunately, this document is silent on the display of an image on a window of a vehicle.

### RELATED ART DOCUMENTS

### Patent Documents

Patent Document 1: JP-2006-227581A (Claims, paragraph [0086], FIG. 2)

Patent Document 2: JP-2007-219258A (Claims, paragraphs [0023], [0033] and [0071], FIG. 6)

Patent Document 3: JP-2010-231080A (Claims, paragraphs [0074], [0110], [0117] and [0119])

Patent Document 4: JP-9-300516A (Claim 1)

### SUMMARY OF THE INVENTION

### Problems to be Solved by the Invention

It is therefore an object of the present invention to provide a polarization laminate that allows a distinct (or sharp) transmission image to be displayed on a translucent screen while maintaining the visibility (such as brightness or distinctness) of a projection image from a projector even in a case where the translucent screen comprises a diffusion-polarization plate; and to provide a translucent projector screen provided with the laminate, a projection system provided with the screen, and a method for improving the visibility of a projection image and a transmission image.

Another object of the present invention is to provide a polarization laminate that allows increase of a front luminance even in a case where an image is projected from a projector on a translucent screen at a wide angle of incidence; and to provide a translucent projector screen provided with the laminate, a projection system provided with the screen, and a method for improving the visibility of a projection image and a transmission image.

It is still another object of the present invention to provide a polarization laminate that makes a translucent screen (semi-transmissive projector screen) thinner and lighter; and to provide a translucent projector screen provided with the laminate, a projection system provided with the screen, and a method for improving the visibility of a projection image and a transmission image.

It is a further object of the present invention to provide a polarization laminate that controls a polarized light emitting from projector to allow proper use of a screen as a transmissive screen or a reflective screen; and to provide a translucent projector screen provided with the laminate, a projection system provided with the screen, and a method for improving the visibility of a projection image and a transmission image.

It is a still further object of the present invention to provide a polarization laminate that allows an image projected on a reflective or transmissive screen from a projector to be seen distinctly from one side and to be hardly seen from the other side; and to provide a translucent projector screen provided with the laminate, a projection system provided with the screen, and a method for improving the visibility of a projection image and a transmission image.

It is another object of the present invention to provide a polarization laminate that allows a projection image from a projector to be seen distinctly from the side at which a projector is not disposed (the other side of a screen) and that prevents reflection of a light source of the projector in the screen; and to provide a translucent projector screen provided with the laminate, a projection system provided with the screen, and a method for improving the visibility of a projection image and a transmission image.

A still another object of the present invention is to provide a polarization laminate that allows a distinct transmission image to be displayed on a translucent screen while maintaining the visibility (such as brightness or distinctness) of a projection image from a projector without being influenced by an ambient brightness (such as an outside light) even in a case where the translucent screen comprises a diffusion-polarization plate; and to provide a translucent projector screen provided with the laminate, a projection system provided with the screen, and a method for improving the visibility of a projection image and a transmission image.

### Means to Solve the Problems

The inventor of the present invention made intensive studies to achieve the above objects and finally found that a translucent projector screen having combination of a diffusion polarization layer and an absorption polarization layer displays a distinct transmission image while maintaining the visibility (such as brightness or distinctness) of a projection image from a projector although the translucent screen has the diffusion-polarization plate, wherein the diffusion polarization layer comprises a continuous phase containing a first transparent thermoplastic resin and a dispersed phase containing a second transparent thermoplastic resin and having a refractive index different from that of the continuous phase, and the diffusion polarization layer has a transmission axis substantially parallel with a transmission axis of the absorption polarization layer. The present invention was accomplished based on the above findings.

That is, an aspect of the present invention provides a transparent polarization laminate as a member or element of a translucent projector screen for displaying a projection image from a projector. The polarization laminate comprises a diffusion polarization layer and an absorption polarization layer, the diffusion polarization layer has a transmission axis substantially parallel with a transmission axis of the absorption polarization layer, and the diffusion polarization layer comprises a continuous phase comprising a first transparent thermoplastic resin and a dispersed phase comprising a second transparent thermoplastic resin and having a refractive index different from that of the continuous phase. The diffusion polarization layer may be capable of polarizing an incident natural light to give first and second linearly polarized light components, and the diffusion polarization layer may diffuse the first light component more than the second light component and may transmit the first light component less than the second light component. The polarization laminate having the polarization layers may have a total light transmittance of not less than 80% and a diffused light transmittance of not more than 25% when a linearly polarized light substantially parallel with the transmission axis enters from the absorption polarization layer side toward the diffusion polarization layer. The polarization laminate may have a total light reflectance of not less than 60% when a linearly polarized light substantially perpendicular to the transmission axis enters from the absorption polarization layer side toward the diffusion polarization layer. The diffusion polarization layer may comprise a stretched film, the continuous phase may have an in-plane birefringence of less than 0.05, the dispersed phase may have an in-plane birefringence of not less than 0.05, and a difference in refractive index for linearly polarized light between the continuous phase and the dispersed phase in a stretching direction may be different from that in a direction perpendicular to the stretching direction. In the diffusion polarization layer, the difference in refractive index between the continuous phase and the dispersed phase in the stretching direction may have an absolute value of 0.1 to 0.3, and the difference in refractive index between the continuous phase and the dispersed phase in the direction perpendicular to the stretching direction may have an absolute value of not more than 0.1. The continuous phase may comprise a polycarbonate, and the dispersed phase may comprise a poly(alkylene naphthalate)-series resin. The dispersed phase may have an elongated (or long) form having an average aspect ratio of 2 to 200, may be substantially uniformly dispersed in the continuous phase, and may have a major-axis direction oriented to a direction substantially parallel with a surface direction of the laminate. The absorption polarization layer may comprise a stretched film of an iodine-containing vinyl alcohol-series resin. The diffusion polarization layer and the absorption polarization layer may be laminated through a transparent adhesive layer. The polarization laminate may further comprise a light-control layer capable of emitting a light at an emitted light intensity less than an incident light intensity. The absorption polarization layer may be interposed between the light-control layer and the diffusion polarization layer. The light-control layer may be capable of regulating a decrease in the emitted light intensity. The polarization laminate having the light-control layer is suitable for a reflective screen.

Another aspect of the present invention provides a translucent projector screen comprising the polarization laminate. The translucent projector screen may be a reflective or transmissive screen (in particular, a short throw projector screen) on which an image from a projector is projected from the diffusion polarization layer side.

A further aspect of the present invention provides a projection system provided with the translucent projector screen and a projector. In the projection system, the diffusion polarization layer may comprise a uniaxially stretched sheet and may be disposed at the projector side, and the projector may be so disposed that a light projected from the projector can enter at an incident angle of more than 0° with respect to a surface direction perpendicular to the stretching direction of the stretched sheet. In the projection system, the projector may be capable of emitting a linearly polarized light having a vibration plane substantially perpendicular to a transmission axis of the diffusion polarization layer, and the translucent projector screen may be a reflective screen. In the projection system, the projector may be capable of emitting a linearly polarized light having a vibration plane substantially parallel with a transmission axis of the diffusion polarization layer, and the translucent projector screen may be a transmissive screen.

Another aspect of the present invention provides a method for improving visibility of an image projected on the translucent projector screen from the projector and a transmission image; the method comprises regulating inside and outside illuminances of the screen and an illuminance of the projector in the projection system.

As used herein, to be “substantially parallel with (or substantially perpendicular to)” does not always mean to be exactly parallel with (or perpendicular to) an objective direction. For example, the term may also mean that two directions intersect at an angle of about ±15° (e.g., ±100, particularly ±5°) or at an angle of about 90±15° (e.g., 90±10°, particularly 90°±5).

The term “translucent screen” (or semi-transmissive) means a screen on which an image can be projected and which has a transparency sufficient to see an indoor or outdoor view of the other side of the screen (or an indoor or outdoor view through the screen). The term “reflective screen” means a screen on which a projection image from a projector can be seen from the side at which the projector is disposed (the obverse side of the screen). The term “transmissive screen” means a screen on which a projection image from a projector can be seen from the side at which the projector is not disposed (the other side of the screen or the reverse side of the screen).

### Effects of the Invention

According to the present invention, a translucent projector screen is provided with a diffusion polarization layer and an absorption polarization layer, the diffusion polarization layer comprises a continuous phase containing a first transparent thermoplastic resin and a dispersed phase containing a second transparent thermoplastic resin and having a refractive index different from that of the continuous phase, and the diffusion polarization layer has a transmission axis substantially parallel with a transmission axis of the absorption polarization layer; the projector screen allows a transmission image (a view of the other side of the screen) to be distinctly seen through as well as maintains the visibility (such as brightness or distinctness) of a projection image from a projector although the projector screen has the diffusion-polarization plate. In particular, use of a specific stretched film as the diffusion polarization layer improves a front luminance even in a case where an image is projected on the translucent screen from a projector at a wide angle of incidence. Moreover, since the polarization laminate of the present invention has a simple structure having the diffusion polarization layer and the absorption polarization layer in combination and regulates a polarized light without an optical retardation plate, the polarization laminate makes a translucent screen (semi-transmissive projector screen) thinner and lighter.

Moreover, since a projection image from a projector is visually recognizable at either an outdoor side or an indoor side by regulating a polarized light emitted from a projector, the polarization laminate is utilizable in different ways for a reflective screen or a transmissive screen. Further, the polarization laminate allows a projection image from a projector to be distinctly seen from one side of the reflective or transmissive screen and to hardly seen from the other side. In particular, the transmissive screen allows a projection image from a projector to be distinctly seen from the side at which the projector is not disposed, and prevents the reflection therein of a light source of the projector. Thus, for example, in a case where the transmissive screen is applied to a window of an automobile or a train, the window is utilizable as a vehicle advertising medium to persons in the outside of the vehicle and allows an outside view (or scenery) through the screen to be seen without losing window function in the vehicle. Meanwhile, in a case where the polarization laminate is utilizable for the reflective screen by regulating a polarized light, the screen is utilizable as a display in a vehicle. In particular, use of the laminate of the present invention as a reflective or transmissive translucent screen allows a distinct view to be seen through from both inside and outside of a room, independent of projection of an image from a projector. For that reason, use of the laminate for a show window display allows an augmented reality experience.

Further, the absorption polarization layer is interposed between the diffusion polarization layer and a light-control layer capable of emitting a light at an emitted light intensity less than an incident light intensity, and the resulting translucent screen displays a distinct transmission image as well as maintains the visibility (such as brightness or distinctness) of a projection image from a projector without being influenced by an ambient brightness (such as an outside light) although the translucent screen has the diffusion-polarization plate. In particular, due to an extremely large intensity of the sunlight, there is an unbalance in light intensity between an outside light and an indoor illuminance in the daytime, and it is difficult to see an image projected on a translucent screen (in particular, a reflective translucent screen) from a projector disposed in a room or a vehicle. Since the light-control layer can reduce the outside light intensity, the visibility of the image is improvable. Further, a light-control layer capable of regulating a decrease in the light intensity can regulate a light intensity to be decreased according to the outside light intensity and also correspond to the change of the outside light intensity. For example, the translucent screen allows the visibility of a projection image to be improved in both the daytime and the nighttime.

### BRIEF DESCRIPTION OF DRAWINGS

FIG. 1 is a schematic diagram for explaining a function of a polarization laminate in a projection system provided with a reflective translucent projector screen in accordance with an embodiment of the present invention and a projector.

FIG. 2 is a schematic perspective view showing a relation between a phase-separation structure of a diffusion polarization layer and a light path of an emission light from the projector in the polarization laminate depicted in FIG. 1.

FIG. 3 is a schematic diagram for explaining a function of a polarization laminate in a projection system provided with a transmissive translucent projector screen in accordance with an embodiment of the present invention and a projector.

FIG. 4 is a graph of a deformation luminance of a diffusion polarization layer obtained in Example 1.

### DESCRIPTION OF EMBODIMENTS

[Polarization Laminate]

The polarization laminate of the present invention is transparent and is a member or element of a translucent (semi-transmissive) projector screen for displaying a projection image from a projector. The polarization laminate comprises a diffusion polarization layer and an absorption polarization layer.

(Diffusion Polarization Layer)

The diffusion polarization layer may be capable of polarizing an incident natural light to give first and second linearly polarized light components, and the diffusion polarization layer may be a linear-polarization layer that diffuses the first light component more than the second light component and transmits the first light component less than the second light component. The diffusion polarization layer comprises a continuous phase containing a first transparent thermoplastic resin and a dispersed phase containing a second transparent thermoplastic resin and having a refractive index different from that of the continuous phase.

(A) Continuous Phase

The first transparent thermoplastic resin for the continuous phase preferably has a low in-plane birefringence (an absolute value of a difference in refractive index between a longitudinal direction and a crosswise direction; particularly, for a stretched film, an absolute value of a difference in refractive index between a stretching direction and a direction perpendicular to the stretching direction). The in-plane birefringence may be less than 0.05, for example, about 0 to 0.03, preferably about 0 to 0.02, and more preferably about 0 to 0.01. According to the present invention, combination of the continuous phase with a dispersed phase having a high in-plane birefringence allows high polarization and anisotropic light diffusion characteristics. The refractive index can be measured at a wavelength of 633 nm by a prism coupler (manufactured by Metricon Corporation).

The first transparent thermoplastic resin may include, for example, a polyolefin, a cyclic polyolefin, a halogen-containing resin (including a fluorine-containing resin), a vinyl alcohol-series resin, a vinyl ester-series resin, a vinyl ether-series resin, a (meth)acrylic resin, a styrene-series resin, a polyester, a polyamide, a polycarbonate, a thermoplastic polyurethane resin, a polysulfone-series resin (such as a polyethersulfone or a polysulfone), a poly(phenylene ether)-series resin (such as a polymer of 2,6-xylenol), a cellulose derivative (such as a cellulose ester, a cellulose carbamate, or a cellulose ether), and a silicone resin (such as a polydimethylsiloxane or a polymethylphenylsiloxane). These transparent thermoplastic resins may be used alone or in combination. Among these transparent thermoplastic resins, the polycarbonate is preferred by reason of low price and high transparency.

The polycarbonate may include an aromatic polycarbonate containing a bisphenol as a base, an aliphatic polycarbonate (such as diethylene glycol bisallylcarbonate), and others. Among them, the aromatic polycarbonate containing a bisphenol as a base is preferred by reason of excellent optical characteristics and low price.

The bisphenol may include, for example, a biphenol (such as dihydroxybiphenyl); a bis(hydroxyaryl)alkane (such as bisphenol A, bisphenol F, bisphenol AD, bis(4-hydroxytolyl)alkane, or bis(4-hydroxyxylyl)alkane) [e.g., a bis(hydroxyaryl) C₁₋₁₀alkane, preferably a bis(hydroxyaryl) C₁₋₆alkane]; a bis(hydroxyaryl)cycloalkane (such as bis(hydroxyphenyl)cyclohexane [e.g., a bis(hydroxyaryl)C₃₋₁₂cycloalkane, preferably a bis(hydroxyaryl) C₄₋₁₀cycloalkane]; a di(hydroxyphenyl) ether (such as 4,4′-di(hydroxyphenyl) ether); a di(hydroxyphenyl) ketone (such as 4,4′-di(hydroxyphenyl) ketone); a di(hydroxyphenyl) sulfoxide (such as bisphenol S); a bis(hydroxyphenyl) sulfone; and a bisphenolfluorene [e.g., 9,9-bis(4-hydroxyphenyl) fluorene and 9,9-bis(4-hydroxy-3-methylphenyl)fluorene]. These bisphenols may be an adduct of a C₂₋₄alkylene oxide. These bisphenols may be used alone or in combination.

The polycarbonate may be a polyestercarbonate-series resin obtainable by copolymerization of dicarboxylic acid components (aliphatic, alicyclic, or aromatic dicarboxylic acids, or acid halides thereof). These polycarbonates may be used alone or in combination. A preferred polycarbonate may include a resin containing a bis(hydroxyphenyl)C₁₋₆alkane as a base, for example, a bisphenol A-based polycarbonate. In the bisphenol A-based polycarbonate, the proportion of copolymerizable monomers other than bisphenol A is, for example, about not more than 20% by mol and preferably about not more than 10% by mol (e.g., about 0.1 to 10% by mol). In particular, the bisphenol A-based polycarbonate has an in-plane birefringence of substantially zero at a stretching ratio of 3 to 5 under the condition described in the after-mentioned Examples.

For the molecular weight of the first transparent thermoplastic resin (in particular, the polycarbonate), for example, the resin may have a viscosity-average molecular weight selected from the range of about 10000 to 200000 (e.g., about 15000 to 150000) as determined from a viscosity measured in a methylene chloride solution having a concentration of 0.7 g/dL at 20° C. For example, the viscosity-average molecular weight is about 15000 to 120000, preferably about 17000 to 100000, and more preferably about 18000 to 50000 (particularly about 18000 to 30000). A first transparent thermoplastic resin having too small a molecular weight tends to make the mechanical strength of the diffusion polarization layer low. A first transparent thermoplastic resin having too large a molecular weight has a low melting flowability and tends to have a low handling in film production or a low uniform dispersibility of the dispersed phase.

The first transparent thermoplastic resin (in particular, the polycarbonate) may have a melt flow rate (MFR) selected from the range of, for example, about 3 to 30 g/10 min. in accordance with ISO 1133 (300° C., 1.2 kg load (11.8 N)). For example, the melt flow rate is about 5 to 30 g/10 min., preferably about 6 to 25 g/10 min., and more preferably about 7 to 20 g/10 min. (particularly about 8 to 15 g/10 min.).

The first transparent thermoplastic resin (in particular, the polycarbonate) has a viscosity of, for example, about 100 to 1500 Pa·s, preferably about 200 to 1200 Pa·s, and more preferably about 300 to 1000 Pa·s (particularly about 500 to 750 Pa·s) when the viscosity is measured by a rotary rheometer (manufactured by Anton Paar) at 270° C. under the condition of a shear rate of 10 sec⁻¹.

The first transparent thermoplastic resin (in particular, the polycarbonate) may have a glass transition temperature selected from the range of, for example, about 110 to 250° C. From the standpoints of a settable lower stretching temperature and a wider selection range of the resin for the dispersed phase, the resin has a glass transition temperature of, for example, about 110 to 180° C., preferably about 120 to 160° C., and more preferably about 130 to 160° C. (particularly about 140 to 155° C.). The glass transition temperature can be measured by a differential scanning calorimeter, for example, can be measured by a differential scanning calorimeter “DSC6200” manufactured by Seiko Instruments & Electronics Ltd.) under a nitrogen flow at a heating rate of 10° C./min.

The continuous phase may comprise a polymer alloy. In a case where the polycarbonate is used as the first transparent thermoplastic resin, for example, the ratio of other transparent thermoplastic resins relative to 100 parts by weight of the polycarbonate is not more than 100 parts by weight, preferably not more than 50 parts by weight, and more preferably not more than 10 parts by weight (e.g., about 0.1 to 10 parts by weight). Concrete examples of the polymer alloy includes a polycarbonate resin composition (a resin composition containing a polycarbonate, a polyester, and an ester exchange reaction catalyst and having a low haze value and a low birefringence) disclosed in Japanese Patent Application Laid-Open Publication No. 9-183892, a polycarbonate resin composition (a resin composition containing a polycarbonate and an aromatic alkenyl compound or vinyl cyanide compound) disclosed in Japanese Patent Application Laid-Open Publication No. 11-3497969, and a polycarbonate resin composition (a resin composition containing a polycarbonate, a polyester, and an epoxy-modified polyolefin) disclosed in Japanese Patent No. 4021741.

The continuous phase comprises the first transparent thermoplastic resin (in particular, the polycarbonate). Specifically, the continuous phase contains the first transparent thermoplastic resin as a main component. The proportion of the first transparent thermoplastic resin in the continuous phase is usually not less than 80% by weight (e.g., about 80 to 100% by weight), preferably about 90 to 100% by weight, and more preferably about 95 to 100% by weight (particularly about 99 to 100% by weight).

(B) Dispersed Phase

The dispersed phase comprises a transparent thermoplastic resin being incompatible with the first transparent thermoplastic resin of the continuous phase and being capable of showing an in-plane birefringence different from that of the continuous phase in the diffusion polarization layer. The transparent thermoplastic resin of the dispersed phase can be selected from the transparent thermoplastic resin exemplified as the first transparent thermoplastic resin. It is preferred that the transparent thermoplastic resin of the dispersed phase have an in-plane birefringence of not less than 0.05. The in-plane birefringence is, for example, about 0.05 to 0.5, preferably about 0.1 to 0.4, and more preferably about 0.15 to 0.3 (particularly about 0.2 to 0.25). For the continuous phase containing the first transparent thermoplastic resin (e.g., the polycarbonate) and the dispersed phase containing the second transparent thermoplastic resin having a large intrinsic birefringence, a high difference in refractive index between the continuous phase and the dispersed phase can effectively be shown even at a low stretching ratio, and a diffusion polarization layer having high scattering characteristics and polarization characteristics can be prepared.

The transparent thermoplastic resin may include, for example, a cyclic olefin-series resin, a vinyl-series resin (such as a poly(vinyl chloride), a vinyl chloride-vinyl acetate copolymer, or a poly(vinylpyrrolidone)), a styrene-series resin (such as a styrene-acrylonitrile resin), an acrylic resin [e.g., a poly((meth)acrylic acid), and a poly(alkyl (meth)acrylate) such as a poly(methyl (meth)acrylate)], an acrylonitrile-series resin (such as a poly(meth)acrylonitrile), a polyester-series resin (such as an amorphous aromatic polyester-series resin, an aliphatic polyester-series resin, or a liquid-crystal polyester), a polyamide-series resin (such as a polyamide 6, a polyamide 66, or a polyamide 610), and a cellulose derivative (such as a cellulose acetate). These transparent thermoplastic resins may be used alone or in combination.

Among these transparent thermoplastic resins, a polyester, particularly a poly(alkylene arylate), is preferred since the polyester has substantially the same refractive index as that of the polycarbonate and can easily increase in refractive index in a stretching direction by stretching. The poly(alkylene arylate) includes a homo- or co-polyester containing an alkylene arylate unit as a main unit, for example, in a proportion of not less than 50% by mol, preferably 75 to 100% by mol, and more preferably 80 to 100% by mol (particularly 90 to 100% by mol). A copolymerizable monomer for the copolyester may include a dicarboxylic acid component (e.g., a C₈₋₂₀aromatic dicarboxylic acid, such as terephthalic acid, isophthalic acid, 2,7-naphthalenedicarboxylic acid, or 2,5-naphthalenedicarboxylic acid; a C₄₋₁₂alkanedicarboxylic acid, such as adipic acid, azelaic acid, or sebacic acid; and a C₄₋₁₂cycloalkanedicarboxylic acid, such as 1,4-cyclohexanedicarboxylic acid), a diol component (e.g., a C₂₋₁₀alkanediol, such as ethylene glycol, propylene glycol, butanediol, or neopentyl glycol; a poly(C₂₋₄alkylene glycol), such as diethylene glycol or a poly(ethylene glycol); a C₄₋₁₂cycloalkanediol, such as 1,4-cyclohexanedimethanol; an aromatic diol, such as bisphenol A); and a hydroxycarboxylic acid component (such as p-hydroxybenzoic acid or p-hydroxyethoxybenzoic acid). These copolymerizable monomers may be used alone or in combination. The poly(alkylene arylate) may include, for example, a poly(C₂₋₄alkylene terephthalate)-series resin [such as a poly(ethylene terephthalate), a poly(propylene terephthalate), or a poly(butylene terephthalate)] and a poly(C₂₋₄alkylene naphthalate)-series resin [such as a poly(ethylene naphthalate), a poly(propylene naphthalate), or a poly(butylene naphthalate)].

Among these poly(alkylene arylate)s, the poly(alkylene naphthalate)-series resin (particularly, a poly(C₂₋₄alkylene naphthalate)-series resin, such as a poly(ethylene naphthalate)-series resin) is preferred since the poly(alkylene naphthalate)-series resin before stretching has a refractive index equivalent to that of the polycarbonate and can easily increase in refractive index in a stretching direction by stretching. The poly(alkylene naphthalate)-series resin may include a homopolyester containing an alkylene naphthalate unit (particularly, a C₂₋₄alkylene naphthalate unit, such as ethylene-2,6-naphthalate) and a copolyester containing an alkylene naphthalate unit in a proportion of not less than 80% by mol (particularly not less than 90% by mol). A copolymerizable monomer for the copolyester may include the above-mentioned dicarboxylic acid component, diol component, hydroxycarboxylic acid, and others. Among these copolymerizable monomers, a dicarboxylic acid component (such as terephthalic acid) is widely used.

For the average molecular weight of the second transparent thermoplastic resin (e.g., a polyester-series resin, such as a poly(alkylene naphthalate)-series resin), the resin may have a number-average molecular weight selected from the range of, for example, about 5000 to 1000000. The number-average molecular weight is, for example, about 10000 to 500000, preferably about 12000 to 300000, and more preferably about 15000 to 100000. A second transparent thermoplastic resin having too large a molecular weight has a low melting flowability and tends to make the aspect ratio of the dispersed phase low. The number-average molecular weight can be measured in terms of polystyrene in a gel permeation chromatography.

The second transparent thermoplastic resin (e.g., a polyester-series resin, such as a poly(alkylene naphthalate)-series resin) has a melt viscosity of, for example, about 200 to 5000 Pa·s, preferably about 300 to 4000 Pa·s, and more preferably about 500 to 3000 Pa·s (particularly about 1000 to 2000 Pa·s) when the melt viscosity is measured by a rotary rheometer (manufactured by Anton Paar) at 270° C. under the condition of a shear rate of 10 sec⁻¹.

The melt viscosity ratio of the first transparent thermoplastic resin (in particular, a polycarbonate) relative to the second transparent thermoplastic resin [the melt viscosity of the first transparent thermoplastic resin/the melt viscosity of the second transparent thermoplastic resin] is, for example, about 2/1 to 1/10, preferably about 2/1 to 1/5, and more preferably about 2/1 to 1/3 (particularly about 1/1 to 1/2.5). In such a range, both resins are sufficiently mixed to uniformly form a dispersed phase having a moderate size in a continuous phase, control the dispersed phase to a moderate particle size, and impart a high in-plane birefringence to the dispersed phase.

The second transparent thermoplastic resin (e.g., a polyester, such as a poly(alkylene naphthalate)-series resin) may have a glass transition temperature selected from the range of, for example, about 50 to 200° C. From the standpoints of easy increase in the aspect ratio of the dispersed phase by stretching, it is preferred that the second transparent thermoplastic resin have a glass transition temperature lower than that of the first transparent thermoplastic resin. For example, the second transparent thermoplastic resin may have a glass transition temperature about 1 to 100° C. lower than that of the first transparent thermoplastic resin, preferably about 5 to 80° C. lower than that of the first transparent thermoplastic resin, and more preferably about 10 to 50° C. (particularly about 20 to 40° C.) lower than that of the first transparent thermoplastic resin. Specifically, the second transparent thermoplastic resin has a glass transition temperature of, for example, about 60 to 180° C., preferably about 80 to 150° C., and more preferably about 90 to 130° C. (particularly about 100 to 120° C.). The glass transition temperature can be measured by a differential scanning calorimeter, for example, can be measured by a differential scanning calorimeter (“DSC6200” manufactured by Seiko Instruments & Electronics Ltd.) under a nitrogen flow at a heating rate of 10° C./min.

The dispersed phase may have an isotropic form. The dispersed phase preferably has an anisotropic form in order to easily show the polarization characteristics, impart anisotropy to the light diffusion characteristics, and improve a front luminance in a case where a light enters from a projector to a screen at a large angle of incidence. The anisotropic form may include, for example, a rugby-ball form (an ellipsoid, such as an ellipsoid of gyration), a flat body, a rectangular form, a rod form, and a fiber form or filiform body. The dispersed phase is usually formed by stretching and has an elongated (or long) form (such as a rod form or a fiber form).

The long dispersed phase has an elongated form (a rod form, a fiber form, or a filiform) having a ratio of an average major-axis length L relative to an average minor-axis length W (average aspect ratio, L/W) of about 2 to 1000. The long dispersed phase has an aspect ratio of, for example, about 2 to 200 (e.g., about 3 to 100), preferably about 4 to 50 (e.g., about 5 to 30), and more preferably about 7 to 15 (particularly about 8 to 12). A long dispersed phase having too small an aspect ratio reduces polarization characteristics and anisotropic light-scattering characteristics, and thus a projection image from a projector at a wide angle of incidence has a low distinctness. A long dispersed phase having too large an aspect ratio causes through-light. For the diffusion polarization layer, the major-axis (longitudinal) direction of the long dispersed phase is oriented to a predetermined direction, that is, X-axis direction (stretching direction), so as to form a long dispersed phase.

The long dispersed phase has an average major-axis length L of, for example, about 0.8 to 10 μm, preferably about 1 to 5 μm, and more preferably about 1.5 to 3 μm. The long dispersed phase has an average minor-axis length W of, for example, about 0.05 to 0.8 μm, preferably about 0.1 to 0.7 μm, and more preferably about 0.2 to 0.6 μm.

The dispersed phase that has an anisotropic form having a major axis and a minor axis (or anisotropic dispersed phase) has an average diameter in the major-axis direction of about 0.8 to 10 μm, preferably about 1 to 5 μm, and more preferably about 1.5 to 3 μm. The dispersed phase has an average diameter in the minor-axis direction of about 0.05 to 0.8 μm, preferably about 0.1 to 0.7 μm, and more preferably 0.2 to 0.6 μm. The dispersed phase has an average aspect ratio (major axis/minor axis) of about 2 to 1000 (e.g., about 2 to 200), preferably about 3 to 500, and more preferably about 5 to 100 (particularly about 7 to 30).

It is preferred that the anisotropic dispersed phase (in particular, the long dispersed phase) be substantially uniformly dispersed in the continuous phase and that the major-axis direction of the dispersed phase be oriented to a given direction substantially parallel with the surface direction of the diffusion polarization layer. Specifically, it is preferred that the anisotropic dispersed phase have a higher orientation coefficient as an index of the degree of orientation. For example, the orientation coefficient may be not less than 0.34 (about 0.34 to 1), preferably about 0.4 to 1 (e.g., about 0.5 to 1), and more preferably about 0.7 to 1 (particularly about 0.8 to 1). The dispersed phase having a higher orientation coefficient can give higher polarization characteristics.

The orientation coefficient can be calculated based on the following formula:

Orientation coefficient=(3<cos² θ>−1)/2

wherein θ represents an angle between the major axis of the dispersed phase and the X-axis of the diffusion polarization layer (when the major axis and the X-axis are parallel with each other, θ=0°), <cos² θ> indicates the average of cos² θ calculated from each dispersed phase particle and is represented by the following formula:

<cos² θ>=∫n(θ)·cos² θ·dθ

wherein n(θ) represents a weight ratio of a dispersed phase having an angle of θ in the whole dispersed phase.

The dispersed phase comprises the second transparent thermoplastic resin (in particular, the poly(alkylene naphthalate)-series resin). Specifically, the dispersed phase contains the second transparent thermoplastic resin as a main component. The proportion of the first transparent thermoplastic resin in the dispersed phase is usually not less than 80% by weight (e.g., about 80 to 100% by weight), preferably about 90 to 100% by weight, and more preferably about 95 to 100% by weight (particularly about 99 to 100% by weight).

The ratio (weight ratio) of the continuous phase (the first transparent thermoplastic resin of the continuous phase) relative to the dispersed phase (the second transparent thermoplastic resin of the dispersed phase) can be selected according to the species, melt viscosity and light diffusion of the resins. For example, the continuous phase/the dispersed phase can be selected from the range of about 99/1 to 50/50, preferably about 98/2 to 70/30, and more preferably about 96/4 to 80/20, and is usually about 95/5 to 85/15. Use of these components in such a ratio allows uniform dispersion of the dispersed phase, prevention of the generation of voids on orientation treatment (e.g., uniaxial stretching), and formation of an excellent diffusion polarization layer, even if pellets of each component are directly melt-kneaded together without compounding both components in advance.

(C) Additive

In the diffusion polarization layer, the dispersed phase is bonded to or adheres closely to the continuous phase without substantially generating a void in an interface with the continuous phase. If necessary, a compatibilizing agent (a compatibilizer) may be added. In a case where the compatibilizing agent is added, the dispersed phase may be bonded to or adhere closely to the continuous phase through the compatibilizing agent.

The compatibilizing agent to be employed usually includes a polymer (a random, block, or graft copolymer) having the same as or common component with the resin constituting the continuous phase or the dispersed phase, a polymer (a random, block, or graft copolymer) having an affinity for the resin constituting the continuous phase or the dispersed phase, and others. Specifically, the compatibilizing agent may include a polyester-series elastomer, a compatibilizing agent having an epoxy group in a main chain thereof, particularly, an epoxy-modified aromatic vinyl-diene-series block copolymer [for example, an epoxidized styrene-diene-series copolymer or epoxy-modified styrene-diene-series copolymer, such as an epoxidized styrene-butadiene-styrene (SBS) block copolymer or an epoxidized styrene-butadiene block copolymer (SB)]. The epoxidized aromatic vinyl-diene-series copolymer has not only a high transparency but also a relatively high softening temperature (about 70° C.). Thus the copolymer makes the first and second resins compatible with each other in many combinations of the continuous phase and the dispersed phase, and the dispersed phase can uniformly be dispersed.

The ratio (weight ratio) of the compatibilizing agent and the dispersed phase [the dispersed phase/the compatibilizing agent (weight ratio)] is about 99/1 to 50/50, preferably about 99/1 to 70/30, and more preferably about 98/2 to 80/20. Moreover, the ratio of the compatibilizing agent is, for example, about 0.1 to 20 parts by weight, preferably about 0.5 to 15 parts by weight, and more preferably about 1 to 10 parts by weight, relative to 100 parts by weight of the total of the continuous phase and the dispersed phase.

The diffusion polarization layer may contain a conventional additive [for example, a stabilizer (such as an antioxidant, a heat stabilizer, or an ultraviolet absorber), a plasticizer, an antistatic agent, a flame retardant, and a filler] as far as the additive does not have a bad influence on optical characteristics.

(Characteristics of Diffusion Polarization Layer)

The diffusion polarization layer may be capable of polarizing an incident natural light to give first and second linearly polarized light components, and the diffusion polarization layer may diffuse the first component more than the second component and may transmit the first component less than the second component. In particular, the diffusion polarization layer has a difference in refractive index for linearly polarized light between the continuous phase and the dispersed phase in a longitudinal direction of the film surface (MD, length direction or machine direction, hereinafter sometimes referred to as “X-axis direction”) different from that in a crosswise direction (CD or width direction, in particular, a direction perpendicular to a stretching direction, hereinafter sometimes referred to as “Y-axis direction”). Thus the polarization layer significantly scatters and slightly transmits a polarized light in a direction having a large difference in refractive index. Part of the polarized light is scattered in front of the polarization layer, and the residual polarized light is scattered behind the polarization layer and is hardly absorbed. The polarization layer almost transmits (slightly scatters and significantly transmits) a polarized light in a direction having a small difference in refractive index. Specifically, in a case where the polarization layer is a stretched film, the layer significantly scatters a linearly polarized light in the stretching direction (e.g., X-axis direction) (a linearly polarized light having a vibration plane substantially parallel with the stretching direction) and slightly or hardly scatters a linearly polarized light in the direction perpendicular to the stretching direction (a linearly polarized light having a vibration plane substantially perpendicular to the stretching direction) less than scattering in the X-axis direction.

Further, the characteristics to a polarized light (second linearly polarized light component) in a direction (Y-axis direction) having a small difference in refractive index may be selected according to the species of the translucent screen. In a case where the translucent screen is used as a reflective screen, it is sufficient that the polarization layer has a function of significantly diffusing the first linearly polarized light component in order to make use of the light scattered in front. Since the second linearly polarized light component is not used, the polarization layer may have a function of transmitting the second linearly polarized light component without diffusion. In a case where the translucent screen is used as a transmissive screen, the second linearly polarized light component having a high transmission is utilized, and it is preferred that the polarization layer have a function of diffusing the second linearly polarized light component to some degree in order to improve a front luminance even at wide angle of incidence.

With respect to the difference in refractive index, the absolute value of the difference in refractive index between the continuous phase and the dispersed phase in one direction (for example, the X-axis direction or the stretching direction) is not less than 0.1 (e.g., about 0.1 to 0.5), preferably about 0.1 to 0.3, and more preferably about 0.1 to 0.2; the absolute value of the difference in refractive index between the continuous phase and the dispersed phase in the other direction (for example, the Y-axis direction or the direction perpendicular to the stretching direction) may be not more than 0.1, and is, for example, not more than 0.05, preferably not more than 0.04, and more preferably not more than 0.03 (e.g., about 0.001 to 0.03). In a case where each of the absolute values of the difference in refractive index is within the each range as described above, the polarization layer has a well-balanced back scattering (reflection) and transmission scattering, and can show excellent polarization characteristics and scattering characteristics and improve a luminance of a display apparatus.

It is preferred that the diffusion polarization layer be a uniaxially stretched film. In the polarization layer having the above-mentioned difference in refractive index, it is preferred that the continuous phase and the dispersed phase each have a small anisotropy in refractive index and have substantially the same refractive index at a stage of a sheet (what is called a cast sheet) in film production. For example, the absolute value of the difference in refractive index between the transparent thermoplastic resin (particularly, the polycarbonate) of the continuous phase and the transparent thermoplastic resin (particularly, the polyester) of the dispersed phase before stretching may be not more than 0.05, preferably not more than 0.04, and more preferably not more than 0.03. In a case where the difference in refractive index between these resins before stretching is within this range, the difference in refractive index in the stretching direction can easily be induced by usual stretching.

Generally, it is known that a uniaxially stretched cast sheet has a significantly increased refractive index in the stretching direction (X-axis direction) of the continuous phase, and a polarizing element is prepared by increasing the refractive index of the transparent thermoplastic resin of the continuous phase without very changing the refractive index of the transparent thermoplastic resin of the dispersed phase. Meanwhile, according to the present invention, in the diffusion polarization layer, the continuous phase has a small change in refractive index even in the X-axis direction, and the particulate dispersed phase has a significant difference in refractive index in the X-axis direction and the Y-axis direction. Specifically, the continuous phase does not show a large difference in refractive index by stretching, while the dispersed phase is deformed into an anisotropic form, (such as a rugby-ball form or a rod form) and shows a large difference in refractive index by stretching.

Thus, according to the present invention, by uniaxial stretching, the refractive index of the continuous phase is significantly different from that of the dispersed phase in the X-axis direction and substantially agrees with that of the dispersed phase in the Y-axis direction. Accordingly, the diffusion polarization layer produced has the following characteristics: the polarized light in the direction in which the continuous phase and the dispersed phase have substantially the same refractive index (for example, a linearly polarized light having a vibration plane substantially parallel with the direction in which the continuous phase and the dispersed phase have substantially the same refractive index) is slightly scattered and significantly transmitted (particularly, substantially transmitted), and the polarized light in the direction in which the refractive index of the continuous phase is different from that of the dispersed phase (for example, a linearly polarized light having a vibration plane substantially parallel with the direction in which the refractive index of the continuous phase is different from that of the dispersed phase) is significantly scattered. Specifically, the diffusion polarization layer comprises a uniaxially stretched film and may have a difference in refractive index for linearly polarized light between the continuous phase and the dispersed phase in the stretching direction different from that in the direction perpendicular to the stretching direction.

According to the present, invention, the dispersed phase has a significant difference in refractive index between the X-axis direction and the Y-axis direction. In the X-axis direction, the larger the difference in refractive index between the continuous phase and the dispersed phase is, the larger the scattering characteristics of the polarized light in the direction is, and the ratio of back scattering (reflected light) is also increased. Further, since the scattering angle is also enlarged, the front luminance can be improved even in a case where a light enters from a projector at a wide angle of incidence. In particular, in a case where predetermined scattering characteristics are imparted to the Y-axis direction in addition to large scattering characteristics to the X-axis direction, the front luminance of a transmissive screen can be improved.

The diffusion polarization layer has a high total light transmittance (a total light transmittance of a linearly polarized light entered in a direction perpendicular to the surface of the diffusion polarization layer) of a linearly polarized light (a linearly polarized light substantially parallel with a transmission axis or a linearly polarized light of a transmission axis) having a vibration plane substantially parallel with a transmission axis of the direction in which there is a smaller difference in refractive index (for a stretched film, the direction perpendicular to the stretching direction) out of the X-axis direction and the Y-axis direction. For example, the total light transmittance of the linearly polarized light of the transmission axis is not less than 80%, e.g., about 80 to 99%, preferably about 82 to 98%, and more preferably about 85 to 95%. In a case where the total light transmittance is too small, a linearly polarized light obtained by polarizing an ambient light (such as a natural light) by the absorption polarization layer has a low luminance, and the view of the other side of the screen has a low visibility. Further, when the screen is used as a transmissive screen, a projection image from a projector has a low luminance and a low distinctness.

Moreover, the diffused light transmittance of the linearly polarized light substantially parallel with the transmission axis (the linearly polarized light entered in the direction perpendicular to the surface of the diffusion polarization layer) may be not more than 50%. In order to improve the visibility of the view of the other side of the screen, for example, the diffused light transmittance may be not more than 25% (e.g., about 0.1 to 25%), preferably about 1 to 20%, and more preferably about 5 to 18% (particularly about 10 to 15%). In a case where the diffused light transmittance is too large, a linearly polarized light obtained by polarizing an ambient light (such as a natural light) by the absorption polarization layer has large scattering, and the view of the other side of the screen has a low distinctness. When the screen is used as a transmissive screen, it is preferred that the diffused light transmittance be not less than 10% (particularly about 15 to 25%). In a case where the diffused light transmittance is too small, the front luminance is low and a projection image has a low visibility.

In contrast, the diffusion polarization layer has excellent characteristics for scattering a linearly polarized light (a linearly polarized light substantially parallel with a scattering axis or a linearly polarized light of a scattering axis) having a vibration plane substantially parallel with a scattering axis of the direction in which there is a larger difference in refractive index out of the X-axis direction and the Y-axis direction (for a stretched film, the stretching direction). The total light transmittance of the linearly polarized light of the scattering axis (a linearly polarized light entered in the direction perpendicular to the surface of the diffusion polarization layer) may be not more than 50%. For example, the total light transmittance may be not more than 40% (for example, about 5 to 40%), preferably about 10 to 35%, and more preferably about 15 to 30% (particularly about 15 to 25%). Specifically, the diffusion polarization layer has a high reflectance (a reflectance of a regular reflection component and a back scattering component) of the linearly polarized light of the scattering axis. The diffusion polarization layer may have a total light reflectance (a back scattering rate) of a linearly polarized light in the above-mentioned direction of not less than 50%, for example, not less than 60% (e.g., about 60 to 95%), preferably about 65 to 90%, and more preferably about 70 to 85% (particularly about 75 to 85%). In a case where the screen is used as a reflective screen, too small a reflectance makes the visibility of a projection image low. The direction showing such a reflectance may be the X-axis direction or the Y-axis direction. In respect of efficient production, or other reasons, the X-axis direction is preferred.

The total light transmittance and the diffused light transmittance can be measured by a polarized-light measuring apparatus (haze meter) (NDH300A manufactured by NIPPON DENSHOKU INDUSTRIES CO., LTD.) as described in the after-mentioned Examples in accordance with Japanese Industrial Standards (JIS) K7361-1 (for total light transmittance) and JIS K7136 (for haze (for diffused light)).

The diffusion polarization layer may have a thickness (average thickness) selected from the range of about 10 to 700 μm, and may have a thickness, for example, about 30 to 600 μm (e.g., about 40 to 500 μm), preferably about 50 to 400 μm (e.g., about 80 to 350 μm), and more preferably about 100 to 300 μm (particularly about 150 to 250 μm).

The diffusion polarization layer may have at least one side (in particular, a side that does not have an absorption polarization layer) having a transparent resin layer laminated thereon; the transparent resin layer does not have a bad influence on optical characteristics. Protection of the diffusion polarization layer with the transparent resin layer can prevent falling off or adhesion of the dispersed phase particle, and thus the polarization layer can have improved abrasion resistance or stable production and increased strength or handleability (handling property).

The resin for the transparent resin layer can be selected from the transparent thermoplastic resin exemplified as the component of the continuous phase or the dispersed phase, a transparent thermosetting resin, and others. A preferred transparent resin layer comprises the same type (in particular, the same) resin as that of the continuous phase, for example, a polycarbonate. The transparent resin layer may contain the above-mentioned conventional additive as far as the additive does not have a bad influence on optical characteristics.

The transparent resin layer has a thickness (average thickness) of, for example, about 3 to 150 μm, preferably about 5 to 50 μm, and more preferably about 5 to 15 μm.

(Process for Producing Diffusion Polarization Layer)

The diffusion polarization layer can be obtained by dispersing and orienting the transparent thermoplastic resin for the dispersed phase in the transparent thermoplastic resin for the continuous phase. For example, the dispersed phase can be dispersed in the continuous phase by blending two kinds of transparent thermoplastic resins and optionally an additive (e.g., a compatibilizing agent) with a conventional manner (e.g., a melt-blending method and a tumbler method) where necessary, melt-mixing the blended matter, and extruding the molten mixture from a T-die, a ring die, or the like into a film form. It is preferred that the melting temperature be not lower than the melting point of the transparent thermoplastic resin. Depending on the species of the resin, for example, the melting temperature is about 150 to 290° C. and preferably about 200 to 260° C.

Next, the orientation treatment of the dispersed phase can be carried out by, for example, (1) a method of stretching an extruded sheet and (2) a method of forming an extruded sheet while drawing to solidify the sheet and then stretching the sheet. In order to show excellent optical characteristics, the following method is preferred: a sheet in which a dispersed phase as a second transparent thermoplastic resin is dispersed in a continuous phase as a first transparent thermoplastic resin by the above-mentioned melting film formation is cooled for solidification to give a cast sheet, the cast sheet is reheated and then oriented by stretching.

The stretching may be a simple uniaxial stretching having free width or a uniaxial stretching having a constant width (fixed width). The uniaxial stretching may include, but should not be limited to, for example, a method in which both ends of a solidified film are pulled in opposite directions (pull stretching); a method using two or more pairs of opposed rollers (2-roll sets) arranged serially (e.g., in a series of 2 pairs), wherein the film is passed over the rollers constituting each roll set by guiding it through the respective roll nips and stretched by driving the 2-roll set on the pay-out side at a speed higher than the speed of the 2-roll set on the feed side (inter-roll stretching); and a method in which the film is passed through the nip of a pair of opposed rollers and stretched under the roll pressure (roll calendering).

Among these uniaxial stretching methods, the pull stretching, in particular, the uniaxial stretching having a free width, is preferably usable in order to surely deform the dispersed phase and increase the in-plane birefringence of the dispersed phase.

Moreover, the uniaxial stretching having a fixed width by tenter method can preferably be used. For the uniaxial stretching having a fixed width by tenter method, the width in the direction perpendicular to the stretching direction is not changed, different from for the uniaxial stretching having a free width; for the uniaxial stretching having a free width, the width in the direction perpendicular to the stretching direction is decreased by stretching, and the thickness tends to be ununiform in the overall width. The uniaxial stretching having a fixed width is an advantageous method in producing a sheet having a maintained anisotropic orientation of the dispersed phase and being uniform in the overall width. Further, the method is effective in changing the refractive index of the dispersed phase, although the details of the action are not clear. For the uniaxial stretching by tenter method, the stretching direction may be the machine direction of the sheet or the width direction of the sheet. In a case where the stretching direction is the machine direction, the production speed is increased, while it is necessary to expand the width of the cast sheet in order to give a polarization layer having a desired width. In contrast, in a case where the stretching direction is the width direction, a polarization layer having a desired width is obtainable due to stretching in the crosswise direction even when the cast sheet has a small width, while the production speed is decreased. These methods can be selected according to purposes. In the uniaxial stretching by tenter method, the tension speed can be selected from the range of, for example, 50 to 1000 mm/min. according to the stretching temperature or the magnification. For example, the tension speed is about 100 to 800 mm/min., preferably about 150 to 700 mm/min. and more preferably about 200 to 600 mm/min. (particularly about 400 to 600 mm/min.).

It is preferred that the stretching temperature be not lower than the glass transition temperature of the first transparent thermoplastic resin (for example, a polycarbonate). When the first transparent thermoplastic resin has a glass transition temperature of Tg, the stretching temperature may be, for example, as high as about Tg to (Tg+80)° C. preferably about (Tg+5) to (Tg+50)° C., and more preferably about (Tg+5) to (Tg+30)° C. [particularly about (Tg+8) to (Tg+20)° C.]. Specifically, the stretching temperature may be, for example, about 120 to 180° C., preferably about 150 to 175° C., and more preferably about 150 to 170° C. (particularly about 160 to 170° C.).

The stretching ratio can be selected from a wide range. According to the present invention, even a relatively low stretching ratio can induce a large difference between the refractive index in the stretching direction and that in the direction perpendicular to the stretching direction. For example, the stretching ratio may be about 1.2 to 10 (e.g., about 1.5 to 8), preferably about 2 to 6, and more preferably about 3 to 5.5 (particularly about 4 to 5). In particular, according to the present invention, even in a case where the stretching ratio is not more than 5, a film having excellent polarization characteristics and scattering characteristics can be produced. Thus, the film can simply be produced using a general-purpose apparatus for stretching (such as above-mentioned uniaxial stretching by tenter method).

The stretching may be a biaxial stretching. For example, the stretching may be a biaxial stretching in which there is a difference in strength between the stretching directions.

Since the diffusion polarization layer is heat-treated under tension (heat-treated while maintaining the length of the film) at a stretching temperature or a temperature higher than a stretching temperature in order to moderate the birefringence of the continuous phase and show the polarization characteristics, the diffusion polarization layer can possesses an improved heat resistance as well as maintained polarization characteristics. The heat-treating temperature can be selected, for example, from not lower than the stretching temperature to a temperature about 50° C. higher than the stretching temperature. For example, the heat-treating temperature may be from not lower than the stretching temperature to a temperature about 30° C. higher than the stretching temperature, e.g., a temperature substantially the same as the stretching temperature. The heat-treating time is, for example, about 0.1 to 30 minutes, preferably about 1 to 10 minutes, and more preferably about 2 to 5 minutes and can be selected depending on the temperature. For example, in a case where the heat-treating temperature is about 165° C., the heat-treating time may be about 2 to 3 minutes. Since the heat treatment can reduce a difference in the refractive index of the continuous phase to allow the refractive index of the continuous phase to agree with that of the dispersed phase in the direction perpendicular to the stretching direction, the optical characteristics can also be improved. Further, the heat treatment can improve the heat resistance (such as dimensional stability) or strength of the diffusion polarization layer.

In a case where the transparent resin layer is laminated, the transparent resin layer may be laminated on at least one side of the diffusion polarization layer by a conventional method, for example, coextrusion molding, lamination (such as extrusion lamination or dry lamination), and other methods.

(Absorption Polarization Layer)

As the absorption polarization layer, a conventional absorption polarizer, for example, a dichroic pigment polarizing plate, a polyene-series polarizing plate, and a wire grid polarizing plate, may be used. Among them, in view of excellent polarization characteristics and versatility, the dichroic pigment polarizing plate is preferred. The dichroic pigment polarizing plate contains a dichroic pigment and a transparent resin.

The dichroic pigment may include, for example, iodine and a dichroic dye (e.g., an azo-series dichroic dye, C.I. Direct Yellow 12, C.I. Direct Red 81, C.I. Direct Orange 39, and C.I. Direct Blue 1). These dichroic pigments may be used alone or in combination. Among these dichroic pigments, in view of excellent polarization characteristics, iodine is preferred.

As the transparent resin, there may be used the transparent thermoplastic resin as exemplified in the paragraph of the continuous phase of the diffusion polarization layer. Among the transparent thermoplastic resins, in view of easy absorption and orientation of the dichroic pigment, a vinyl alcohol-series resin is preferred. The vinyl alcohol-series resin may include, for example, a poly(vinyl alcohol) and an ethylene-vinyl alcohol copolymer. The vinyl alcohol-series resin has an average degree of polymerization of, for example, about 1000 to 10000 (particularly about 1500 to 5000). The vinyl alcohol-series resin may be crosslinked with a usual crosslinking agent. Among them, a poly(vinyl alcohol) crosslinked with boric acid is widely used. The poly(vinyl alcohol) has a saponification degree of, for example, about 85 to 100% by mol (particularly about 90 to 100% by mol).

The absorption polarization layer has a high total light transmittance of a linearly polarized light substantially parallel with the transmission axis (a high total light transmittance of a linearly polarized light entered in the direction perpendicular to the surface of the absorption polarization layer). For example, the absorption polarization layer has a total light transmittance of a linearly polarized light of a transmission axis of not less than 80%, e.g., about 80 to 95%, preferably about 85 to 95%, and more preferably about 89 to 93%. In a case where the total light transmittance is too small, the transmitted linearly polarized light has a low luminance, the view of the other side of the screen has a low visibility.

Further, in order to improve the visibility of the view of the other side of the screen, the diffused light transmittance of the linearly polarized light of the transmission axis (a diffused light transmittance of a linearly polarized light entered in the direction perpendicular to the surface of the absorption polarization layer) may be, for example, not more than 20%, preferably about 0.1 to 20%, and more preferably about 1 to 15%. In a case where the diffused light transmittance is too large, the view of the other side of the screen has a low distinctness due to increase in scattering of the transmitted linearly polarized light.

On the other hand, the linearly polarized light of the absorption axis is highly absorbed to the absorption polarization layer. The total light transmittance of the linearly polarized light of the absorption axis of the absorption polarization layer is not more than 20%, preferably about 0.1 to 20%, and more preferably about 1 to 10%.

Further, when the absorption polarization layer is used for a reflective screen, the absorption polarization layer may have the above-mentioned total light transmittance of not more than 3%, e.g., about 0.001 to 3%, preferably about 0.01 to 1%, and more preferably about 0.05 to 0.8%, in order to absorb a linearly polarized light component scattered behind the absorption polarization layer and hardly allow visual recognition of a projection image from the side at which the projector is not disposed (the other side of the screen). As the characteristics necessary for showing the performance of the reflective screen, the absorption polarization layer may have a polarization degree of not less than 95% (preferably not less than 99%) and a single transmittance of not less than 40% (preferably not less than 44%). As used herein, the polarization degree and the single transmittance can be determined according to the following method.

Polarization degree={[Tp−To]/[Tp+To]}×100%

Single transmittance={[Tp+To]/2}×100%

wherein Tp is a transmittance in a case where a polarized light having a vibration plane parallel with a transmission axis of a polarizing plate to be measured transmits the polarizing plate, and To is a transmittance in a case where a polarized light having a vibration plane perpendicular to a transmission axis of a polarizing plate to be measured transmits the polarizing plate.

The absorption polarization layer has a thickness (average thickness) of about 10 to 300 μm, preferably about 15 to 100 μm, and more preferably about 20 to 50 μm.

The absorption polarization layer may have a transparent resin layer (protective layer) laminated on at least one side thereof as far as the optical characteristics are not damaged. The transparent resin layer may comprise a resin selected from the transparent thermoplastic resin exemplified as the component of the continuous phase or the dispersed phase, a transparent thermosetting resin, and other resins. A preferred transparent resin layer comprises a cellulose ester (such as a cellulose triacetate), a (meth)acrylic resin (such as a poly(methyl methacrylate)), a cyclic polyolefin (such as an ethylene-norbornene copolymer), a polyester (such as a poly(ethylene terephthalate), or others. The transparent resin layer may contain the conventional additive (for example, an ultraviolet absorber) as exemplified in the paragraph of the diffusion polarization layer.

Further, in order to improve the visibility, the absorption polarization layer may have a first side having the diffusion absorption layer and a second side having an antireflective layer.

The absorption polarization layer can be produced by a usual method. For example, the absorption polarization layer containing a dichroic pigment can be produced through a step of staining a vinyl alcohol-series resin film with a dichroic pigment (e.g., combination of iodine and potassium iodide) and a step of heat-stretching the stained vinyl alcohol-series resin film in an aqueous solution containing a crosslinking agent (e.g., boric acid). In the stretching step, the film may be uniaxially stretched, for example, at a stretching ratio of about 2 to 10 (particularly about 3 to 8). As the stretching method, for example, there may be used the method as exemplified in the paragraph of the process for producing the diffusion polarization layer.

(Light-Control Layer)

The polarization laminate may further comprise a light-control layer in order to regulate (or control) outside and inside (in-room or in-vehicle) illuminances and improve the visibility of a projection image and a transmission image.

The light-control layer may be disposed at any side of the polarization laminate. In order to effectively regulate an intensity of an ambient light having a large illuminance (such as the sunlight), the light-control layer is preferably disposed at the absorption polarization layer side so that the absorption polarization layer may be interposed between the light-control layer and the diffusion polarization layer.

The light control layer is capable of emitting a light at an emitted light intensity less than an incident light intensity. The light-control layer may be a constant light-control layer that reduces a light intensity at a constant rate or may be a variable light-control layer that can regulate the decrease in a light intensity.

As the constant light-control layer, there may be used a transparent resin layer containing a light-absorbable pigment, for example, a conventional neutral density filter (ND filter). A transparent resin for the neutral density filter may include the transparent thermoplastic resin (in particular, e.g., a cellulose ester, a polyester) exemplified in the paragraph of the continuous phase of the diffusion polarization layer. The light-absorbable pigment may include, for example, a cyanine-series pigment, a phthalocyanine-series pigment, an azo-series pigment, and a xanthene-series pigment.

The light intensity to be decreased by the constant light-control layer can be selected according to the purposes. The ratio of the emitted light intensity relative to the incident light intensity may be, for example, about 1 to 90%, preferably about 3 to 50%, and more preferably about 5 to 30% (particularly about 8 to 20%).

As the variable light-control layer, there may be employed a usual light-control layer capable of regulating the decrease in the light intensity by various means (such as an electrical switching). For example, the variable light-control layer may include a liquid-crystal shutter that regulates a light intensity by applying a voltage to change an orientation state of a liquid-crystal layer; an electrochromic layer that regulates a light intensity by applying a voltage to change a light absorption of a metal oxide (such as tungsten oxide) or a pigment; a photochromic layer that uses dissociation of silver halide by ultraviolet light for coloration; a light-control mirror that regulates a light intensity by applying a voltage or introducing a gas (such as hydrogen gas) to change a light transmission (reflectiveness) of a metallic film (such as a magnesium-nickel alloy thin film); and a blind that regulate a light intensity by mechanical opening and closing operation.

The light intensity to be decreased by the variable light-control layer can be selected according to the purposes, and the decrease in the light intensity can be regulated in a wide range. The ratio of the emitted light intensity relative to the incident light intensity may be regulated in the range of, for example, about 0 to 90%, preferably about 1 to 80%, and more preferably about 3 to 70% (particularly about 5 to 50%). In order to ensure the visibility of both a projection image on the translucent screen of the present invention and a view of the other side of the translucent screen, it is necessary to adjust the light intensity to be decreased by the variable light-control layer to more than 0%. The emitted light intensity of the variable light-control layer may temporarily be adjusted to substantially 0%. In that case, the translucent screen of the present invention may temporarily be used as an opaque screen. For example, the screen can be used properly depending on a time zone. In the daytime, the screen can be used as a translucent screen to ensure the visibility of both the projection image and the view of the other side; in the nighttime, the screen can be made opaque by the variable light-control layer in order to ensure only the visibility of the projection image for an observer in a room.

Among them, in respect of maintaining the visibility regardless of drastic change of the outside light intensity (e.g., the daytime and the nighttime), the variable light-control layer is preferred. In respect of adjustment in a wide range of a light intensity, excellent response, and easy adjustment, the liquid-crystal shutter is particularly preferred.

The liquid-crystal shutter may include a conventional liquid-crystal shutter as far as the liquid-crystal shutter can reduce a light intensity by changing the orientation of a liquid-crystal molecule in an application of an electric field to change the light transmission or orientation. The liquid-crystal shutter usually comprises a laminate having an electrically switchable liquid-crystal layer between first and second absorption polarization layers.

For the liquid-crystal shutter, a light is polarized by transmitting the first absorption polarization layer, and the orientation direction of the polarized light is changed by the liquid-crystal layer in order to regulate the transmission of the light to the second absorption layer. The transmission axis of the first polarization layer and that of the second absorption polarization layer may be parallel with or perpendicular to each other, which can be adjusted with the orientation degree of the liquid-crystal layer, and selected according to an objective decrease of the light intensity.

As the first and second absorption polarization layers, there may be used the absorption polarization layer exemplified in the paragraph of the absorption polarization layer of the polarization laminate. The liquid-crystal shutter is usually laminated in contact with the diffusion polarization layer of the polarization laminate. A three-layer liquid-crystal shutter may be laminated on the absorption polarization layer of the polarization laminate, or the absorption polarization layer of the polarization laminate may serve as the absorption polarization layer (the second absorption polarization layer) of the liquid-crystal shutter. In the latter case, the translucent screen of the present invention may be obtained by laminating a diffusion polarization layer alone on a commercially available liquid-crystal shutter, and the light-control layer seemingly has a two-layer structure composed of the first absorption polarization layer and the liquid-crystal layer.

The liquid crystal constituting the liquid-crystal layer may include, for example, a nematic liquid crystal, a smectic liquid crystal, a cholesteric liquid crystal, and a discotic liquid crystal. Among them, in light of an excellent orientation due to an electric field, the nematic liquid crystal or the cholesteric liquid crystal is preferred.

The liquid-crystal shutter may include, for example, liquid-crystal shutters described in Japanese Patent Application Laid-Open Publication Nos. 5-88209, 11-514457, and 2002-268069.

The polarization laminate provided with the light-control layer is suitable for a reflective screen in the respect that the laminate can reduce an intensity of an outside light having a large illuminance (such as the sunlight) and improve the visibility of a projection image for an observer inside of a room or a vehicle.

The light-control layer has a thickness (average thickness) of about 1 μm to 1 mm, preferably about 10 to 500 μm, and more preferably about 30 to 300 μm.

(Adhesive Layer)

The layers (for example, the diffusion polarization layer and the absorption polarization layer) of the laminate may be laminated through a transparent adhesive layer. The adhesive layer comprises a transparent binder resin that allows the diffusion polarization layer to adhere to the absorption polarization layer. The transparent binder resin may include, for example, a conventional adhesive resin or cohesive (or sticky) resin.

The adhesive resin may include, for example, a thermoplastic resin (e.g., a polyolefin, a cyclic polyolefin, an acrylic resin, a styrene-series resin, a vinyl acetate-series resin, a polyester, a polyamide, and a thermoplastic polyurethane) and a thermosetting resin (e.g., an epoxy resin, a phenol resin, a polyurethane, an unsaturated polyester, a vinyl ester resin, a diallylphthalate resin, a polyfunctional (meth)acrylate, a urethane (meth)acrylate, a silicone (meth)acrylate, a silicone resin, an amino resin, and a cellulose derivative). These adhesive resins may be used alone or in combination.

The cohesive resin may include, for example, a terpene resin, a rosin-series resin, a petroleum resin, rubber-series agglutinant (or adhesive or pressure sensitive adhesive), a modified polyolefin, an acrylic agglutinant, and a silicone-series agglutinant. These cohesive resins may have a crosslinkable group (e.g., an isocyanate group, a hydroxyl group, a carboxyl group, an amino group, an epoxy group, a methylol group, and an alkoxysilyl group). These binder components may be used alone or in combination.

Among these transparent binder resins, the acrylic agglutinant or the silicone-series agglutinant is preferred in respect of excellent optical characteristics and easy handling.

The acrylic agglutinant may include, for example, an agglutinant comprising an acrylic copolymer containing a C₂₋₁₀alkyl acrylate (such as ethyl acrylate, butyl acrylate, or 2-ethylhexyl acrylate) as a main component. A copolymerizable monomer for the acrylic copolymer may include, for example, a (meth)acrylic monomer [e.g., (meth)acrylic acid, methyl (meth)acrylate, hydroxyethyl (meth)acrylate, hydroxypropyl (meth)acrylate, dimethylaminoethyl (meth)acrylate, glycidyl (meth)acrylate, (meth)acrylamide, and N-methylolacrylamide], a polymerizable nitrile compound [e.g., (meth)acrylonitrile], an unsaturated dicarboxylic acid or a derivative thereof (e.g., maleic anhydride and itaconic acid), a vinyl ester (e.g., vinyl acetate and vinyl propionate), and an aromatic vinyl compound (e.g., styrene).

As the silicone-series agglutinant, there may be used an agglutinant containing a silicone rubber component and a silicone resin component dissolved in an organic solvent; the silicone rubber component may include, e.g., an MQ resin composed of a monofunctional R₃SiO_{1/2} (wherein R represents an alkyl group (such as methyl group), an aryl group (such as phenyl group), or other groups, the same applies hereinafter) and tetrafunctional SiO₂, and the silicone resin component may include, for example, a bifunctional R₂SiO alone, or an oily or gummy component containing a combination of a bifunctional R₂SiO and a monofunctional R₃SiO_{1/2}. The silicone rubber component may be crosslinked.

The adhesive layer may contain the conventional additive (for example, an ultraviolet absorber) exemplified in the paragraph of the diffusion polarization layer.

The adhesive layer has a thickness (average thickness) of, for example, about 1 to 100 μm, preferably about 2 to 80 μm, and more preferably about 3 to 70 μm (particularly about 5 to 50 μm).

(Structure and Characteristics of Polarization Laminate)

In the polarization laminate, the diffusion polarization layer and the absorption polarization layer are laminated so that the transmission axis of the diffusion polarization layer may substantially be parallel with that of the absorption polarization layer. Thus a light entered from the absorption polarization layer side transmits the absorption polarization layer to give a linearly polarized Light, and the linearly polarized light can transmit the diffusion polarization layer at a high transmittance; a light entered from the diffusion polarization layer side transmits the diffusion polarization layer to give a linearly polarized light, and the linearly polarized light can transmits the absorption polarization layer at a high transmittance; and an image from a projector can be projected on the diffusion polarization layer. Accordingly, the view of the other side of the screen can distinctly be seen through from the diffusion polarization layer side and the absorption polarization layer side, and the image projected on the screen from the projector can also be seen distinctly.

The polarization laminate has a high total light transmittance of a linearly polarized light substantially parallel with the transmission axis. When a linearly polarized light substantially parallel with the transmission axis enters from the absorption polarization layer side (when a linearly polarized light enters in the direction perpendicular to the surface of the absorption polarization layer), the total light transmittance may be not less than 80%, for example, about 80 to 99%, preferably about 82 to 98%, and more preferably about 85 to 95%. In a case where the total light transmittance is too small, a transmitting linearly polarized light has a low luminance, and the view of the other side of the screen has a low visibility. In a case where the polarization laminate is used for a transmissive screen, a projection image from a projector has a low luminance and a low distinctness.

Further, when a linearly polarized light substantially parallel with the transmission axis enters from the absorption polarization layer side (when a linearly polarized light enters in the direction perpendicular to the surface of the absorption polarization layer), the diffused light transmittance may be not more than 50%. In order to improve the visibility of the view of the other side of the screen, the diffused light transmittance may be, for example, not more than 25% (e.g., about 0.1 to 25%), preferably about 1 to 20%, and more preferably about 5 to 18% (particularly about 10 to 15%). In a case where the diffused light transmittance is too large, a transmitting linearly polarized light has a large scattering, and the view of the other side of the screen has a low distinctness. In a case where the polarization laminate is used for a transmissive screen, it is preferred that the diffused light transmittance be not less than 10% (particularly about 15 to 25%). In a case where the diffused light transmittance is too small, the front luminance is low and a projection image has a low visibility.

On the other hand, the polarization laminate has a high reflectance of a linearly polarized light in the direction substantially perpendicular to the transmission axis (the scattering axis of the diffusion polarization layer and the absorption axis of the absorption polarization layer). When a linearly polarized light substantially perpendicular to the transmission axis enters, the total light reflectance may be not less than 50%, for example, not less than 60% (e.g., about 60 to 95%), preferably about 65 to 90%, and more preferably about 70 to 85% (particularly about 75 to 85%). Thus, according to the present invention, since the linearly polarized light substantially perpendicular to the transmission axis has a high reflectance, when a light of a projector (in particular, a linearly polarized light substantially perpendicular to the transmission axis) enters from the diffusion polarization layer side, the light has a high reflectance; thus in a case where the laminate is used for a reflective screen, the projection image from the projector has an improved visibility.

The polarization laminate may have other functional layers, for example, another polarization layer, an anti-glare layer, an antireflective layer, an antistatic layer, a hard-coat layer, a wavelength correction layer, a low refractive index layer, a high refractive index layer, a light absorption layer (a pigment-containing layer), and an optical retardation layer. According to the present invention, in a case where the polarization laminate utilizes a linearly polarized light, an optical retardation plate is not necessary. This makes the laminate thinner. Thus, the polarization laminate of the present invention may be free from an optical retardation plate.

The thickness ratio (average thickness ratio) of the diffusion polarization layer relative to the absorption polarization layer [the diffusion polarization layer/the absorption polarization layer] is about 1/1 to 50/1, preferably about 2/1 to 30/1, and more preferably about 3/1 to 20/1 (particularly about 5/1 to 15/1).

The polarization laminate has a thickness (average thickness) of, for example, about 100 to 1000 μm, preferably about 150 to 800 μm, and more preferably about 180 to 500 μm (particularly about 200 to 300 μm). Since the polarization laminate of the present invention has a simple structure containing a combination of specific diffusion polarization layer and absorption polarization layer and can regulate a polarized light without an optical retardation plate, the polarization laminate as a translucent screen, even having such a small thickness, makes it possible to achieve both excellent visibility of a projection image and that of a transmission image.

[Translucent Projector Screen and Projection System]

The translucent (semi-transmissive) projector screen of the present invention comprises at least the polarization laminate, is transparent, and is a translucent screen for displaying a projection image from a projector. Further, the translucent projector screen of the present invention is utilizable for a reflective screen on which an image from a projector is projected from the diffusion polarization layer side (that is, the screen has the diffusion polarization layer disposed at the projector side, and a projection image from a projector is seen by an observer from the diffusion polarization layer side) or a transmissive screen on which an image from a projector is projected from the diffusion polarization layer side (that is, the screen has the diffusion polarization layer disposed at the projector side, and a projection image from the projector is seen by an observer from the absorption polarization layer side).

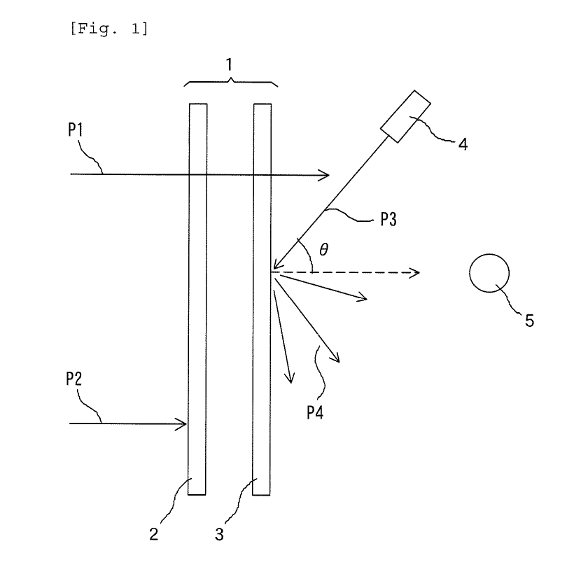

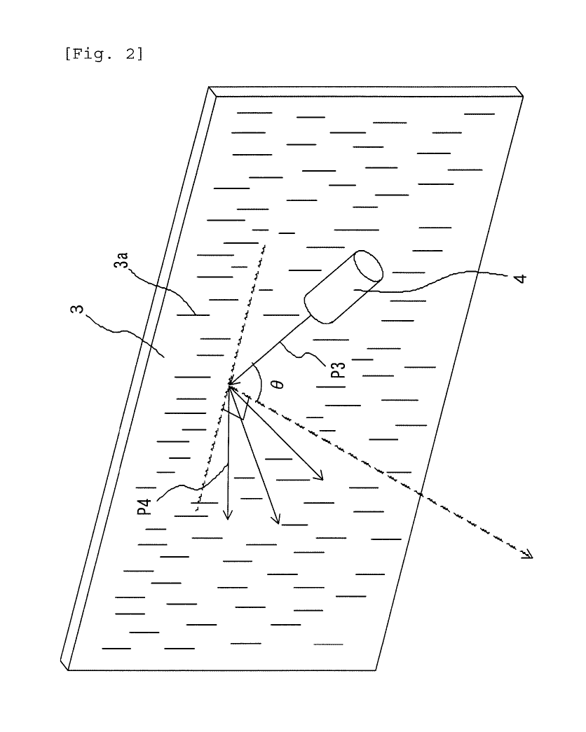

FIG. 1 is a schematic diagram for explaining a function of a polarization laminate in a projection system provided with a reflective translucent projector screen in accordance with an embodiment of the present invention and projector. FIG. 2 is a schematic perspective view showing a relation between a phase-separation structure of a diffusion polarization layer and a light path of an emission light from the projector in the polarization laminate depicted in FIG. 1.

According to the present invention, as shown in FIG. 1, a polarization laminate 1 comprises an absorption polarization layer 2 and a diffusion polarization layer 3. The absorption polarization layer 2 side (the left of the laminate in FIG. 1) corresponds to the other side of the screen. A projector 4 is disposed at the diffusion polarization layer 3 side. An image projected on the diffusion polarization layer 3 from the projector 4 can be seen (or visually recognized) by an observer 5. A linearly polarized light P3 having a vibration plane substantially parallel with the scattering axis of the diffusion polarization layer is emitted from the projector 4 to the diffusion polarization layer at an incident angle θ.

FIG. 2 represents a relation between a light path of reflection on the diffusion polarization layer 3 of the linearly polarized light P3 emitted from the projector 4 and a phase-separation structure of the diffusion polarization layer 3 (the stretching direction of the sheet). The diffusion polarization layer 3 contains a long dispersed phase 3a and is a uniaxially stretched film having an anisotropic light diffusion function. The layer 3 is disposed so that the longitudinal direction of the long dispersed phase 3a may agree with the gravitational direction. While, the projector 4 is disposed so that the linearly polarized light P3 may enter the diffusion polarization layer 3 at an incident angle θ over 0° in a surface direction perpendicular to the stretching direction of the stretched film (the longitudinal direction of the long dispersed phase 3a). Thus since the linearly polarized light P3 can selectively be diffused in a horizontal direction by the diffusion polarization layer 3, the viewing angle characteristics of the screen can be improved. Specifically, a reflected light P4 of the linearly polarized light P3 has a wide range of a reflection angle; even in a case where the linearly polarized light P3 enters at a wide angle of incidence with respect to the diffusion polarization layer 3, the observer 5 can see a distinct image from the normal line direction (the direction of the arrow drawn in broken line) of the screen.

Meanwhile, for the translucent projector screen and projection system of the present invention, the view of the other side of the screen can be seen by an outside light (e.g., a non-polarized light, such as a natural light). As shown in FIG. 1, a linearly polarized light P1 substantially parallel with the transmission axis of the absorption polarization layer 2 in the outside light transmits the absorption polarization layer 2, and further transmits the diffusion polarization layer 3, of which the transmission axis agree with that of the absorption polarization layer, and is seen by the observer 5. Moreover, a linearly polarized light P2 substantially parallel with the absorption axis of the absorption polarization layer 2 is absorbed in the absorption polarization layer 2. Thus, the linearly polarized light P2 is not scattered by the diffusion polarization layer 3, does not generate haze, or does not damage the visibility of the view of the other side. Further, in the linearly polarized light P3 emitted from the projector 4, a linearly polarized light transmitted without reflection by the diffusion polarization layer 3 (not shown) is also absorbed in the absorption polarization layer 2, and the generation of haze can be prevented. Thus, the screen has an improved visibility of the view of the other side.

By making the projection direction of the projector 4 at a wide angle, or by increasing the polarization degree of the absorption polarization layer 2 to decrease the total light transmittance of the linearly polarized light of the absorption axis, an observer (not shown) in the side at which the projector 4 is not disposed (the other side of the screen or outdoor side) can hardly see a projection image.

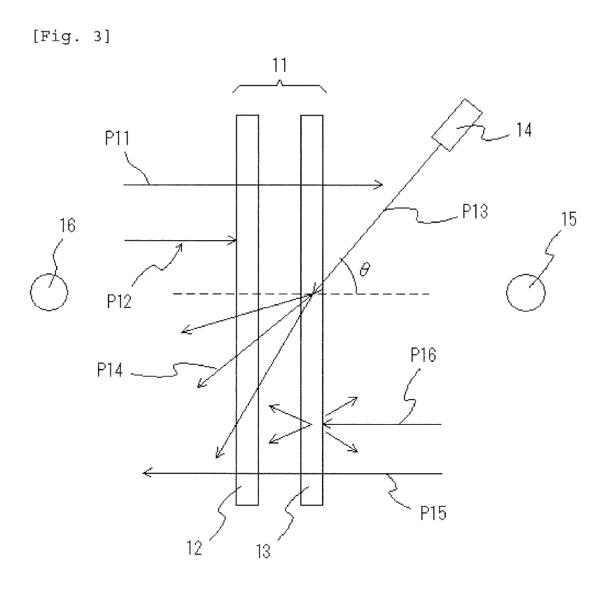

FIG. 3 is a schematic diagram for explaining a function of a polarization laminate in a projection system provided with a transmissive translucent projector screen in accordance with the present invention and a projector. The relation between the phase-separation structure of the diffusion polarization layer and the position of the projector disposed is the same as that in FIG. 2 for the reflective translucent projector screen.

In the transmissive translucent screen, as shown in FIG. 3, a polarization laminate 11 comprises an absorption polarization layer 12 and a diffusion polarization layer 13. The absorption polarization layer 12 side (the left of the laminate in FIG. 3) corresponds to the other side of the screen. A projector 14 is disposed at the diffusion polarization layer 13 side. Differently from the reflective screen, the transmissive screen intends that an observer 16 in the side at which the projector 14 is not disposed (the outdoor side) see an image projected on the diffusion polarization layer 3 from the projector 14. Differently from the reflective screen, a linearly polarized light P13 having a vibration plane substantially parallel with the transmission axis of the diffusion polarization layer is emitted from the projector 14 at an incident angle θ.

For the transmissive translucent screen, the projector 14 is also disposed so that the linearly polarized light P13 may enter the diffusion polarization layer 13 at an incident angle θ over 0°. Differently from the reflective type, the linearly polarized light P13 transmits the diffusion polarization layer 13. Since the linearly polarized light P13 has a vibration plane substantially parallel with the transmission axis of the diffusion polarization layer, the polarized light P13 transmits the diffusion polarization layer at a small scattering angle compared with the case of the reflective screen. When the polarized light P13 transmits the diffusion polarization layer 13, the light is diffused in some degree to give a linearly polarized light P14 which is emitted from the polarization laminate 11. Thus, the linearly polarized light P14, which transmitted the absorption polarization layer 12 having a transmission axis agreeing with that of the diffusion polarization layer 13, has a certain front luminance for the observer 16 in the outdoor side and affords an improved visibility. Further, unlike a conventional transmissive screen, since the linearly polarized light enters at a predetermined angle θ, reflection of a light source of the projector 14 in the screen is prevented.

Further, the observer 16 can observe an indoor view (a look of a room) by an indoor light (such as an artificial light or a natural light). Specifically, a linearly polarized light P15 substantially parallel with the transmission axis of the diffusion polarization layer 13 in the indoor light transmits the diffusion polarization layer 13 with scattering (the scattering is not shown in FIG. 3) and then transmits the absorption polarization layer 12 having a transmission axis agreeing with that of the diffusion polarization layer, and is seen by the observer 16. Moreover, part of a linearly polarized light P16 having a vibration plane substantially parallel with the absorption axis of the diffusion polarization layer 13 is scattered and reflected in front by the diffusion polarization layer 13, the rest is transmitted and scattered behind and then is absorbed in the absorption polarization layer 12. Thus, the linearly polarized light P16 having a large scattering angle does not generate haze or reduce the visibility of the indoor view.

Since the transmission axis of the linearly polarized light P14 emitted from the projector 14 is allowed to agree with the transmission axis of the diffusion polarization layer 13, the linearly polarized light P14 transmits the diffusion polarization layer 13 without reflection. Thus, an observer 15 in the side at which the projector 14 is not disposed (the outdoor side) hardly sees an image projected on the screen from the projector. Incidentally, an observer 15 can distinctly see the outside view in the state that the generation of haze is prevented, because, in the same manner as the reflective screen shown FIG. 1, a linearly polarized light P11 substantially parallel with the transmission axis of the absorption polarization layer 12 transmits the absorption polarization layer 12 and then transmits the diffusion polarization layer 13 having a transmission axis agreeing with that of the absorption polarization layer.

For the translucent projector screen and the projection system of the present invention, any light can be used as the light emitted from the projector as far as the light contains a light that is reflected or transmitted and scattered by the diffusion polarization layer. The light may include, but should not be limited to a linearly polarized light parallel with the scattering axis or transmission axis of the diffusion polarization layer, a non-polarized light (such as a natural light) and other polarized lights (a circularly polarized light, an elliptically polarized light). In order to improve the visibility of the projection image from the projector and the visibility of the view of the other side of the screen, a linearly polarized light substantially parallel with the scattering axis or transmission axis of the diffusion polarization layer is preferred. Further, the system of the present invention allows proper use of the screen as a reflective screen or a transmissive screen according to the circumstances by suitably changing the species of the linearly polarized light to be emitted from the projector. In order to strictly distinguish the reflective type from the transmissive type (in order to see a projection image only from one side), use of a linearly polarized light is desired. Use of an elliptically polarized light at a controlled incident angle also allows the preparation of a screen on which an image from one side can be seen relatively distinctly.

The projection direction of the projector is not particularly limited to a specific one. The incident angle θ of the linearly polarized light component with respect to the screen may be 0°. A wide angle of incidence is preferred in that the projection system for the reflective screen can be downsized or in that reflection of a light source of the projector for the transmissive screen can be prevented. According to the present invention, since the diffusion polarization layer has diffused reflection characteristics or diffused transmission characteristics, the visibility can be ensured even when the incident angle is a wide angle. In particular, for the diffusion polarization layer containing the long dispersed phase, since the visibility can be improved even when the light enters at a wide angle of incidence, it is preferred that the light emitted from the projector enter at an incident angle θ over 0° in the surface direction perpendicular to the stretching direction. In particular, in a case where the diffusion polarization layer is used for the reflective screen, the incident angle θ of the linearly polarized light component may be, for example, not more than 85° (e.g., about 10 to 85°), preferably about 30 to 80°, and more preferably about 45 to 75° (particularly about 50 to 70°) in order that the diffusion polarization layer may absorb a linearly polarized light component scattered behind and that the projection image may hardly be seen from the side at which the projector is not disposed. In a case where the diffusion polarization layer is used for the transmissive screen, the incident angle θ of the linearly polarized light component may be, for example, not more than 80° (e.g., about 5 to 80°), preferably about 10 to 60°, and more preferably about 15 to 45° in order that reflection of the light source of the projector may be prevented.

[Method for Improving Visibility of Projection Image and Transmission Image]

According to the present invention, in the projection system, the visibility of both an image projected on the translucent projector screen from the projector and a transmission image may be improved by regulating inside and outside illuminances of the screen and an illuminance of the projector in the projection system.

The method for regulating the illuminances can be selected according to the species of the projection system. For the projection system provided with the reflective screen, the visibility of both the projection image and the transmission image (the view of the other side of the screen) can be ensured by regulating the illuminance of the outside light that transmits the translucent screen and the illuminance of the projector to get close together. Preferably, the former illuminance and the latter illuminance are regulated so that the difference (absolute value) between the former illuminance and the latter illuminance may have, for example, not more than 1000 lx, preferably not more than 800 lx, and more preferably not more than 600 lx (particularly not more than 500 lx). The method to be used for regulating these illuminances may include a method of regulating the illuminance of the projector, a method of using the polarization laminate provided with the light-control layer, and other methods. Among these methods, the method of using the polarization laminate provided with the light-control layer is preferred in that an outside light having a large illuminance (such as the sunlight) can also be regulated.

The illuminance of the projector side (the in-room or in-vehicle illuminance) may also be regulated by an artificial light according to the purposes. In order to improve the visibility of the projection image and that of the transmission image, it is preferred the illuminance of the projector side be lower. For example, the illuminance of the projector side may be not more than the illuminance of the outside light or the illuminance of the projector. Moreover, in an application for allowing an observer outside of a room or a vehicle to see the indoor or in-vehicle view, the artificial light may be regulated to a suitable illuminance. In chat case, the difference (absolute value) between the illuminance of the projector side (the in-room or in-vehicle illuminance) and the illuminance of the outside light or that of the projector may be, for example, about not more than 1500 lx, preferably not more than 1200 lx, and more preferably not more than 1000 lx (particularly not more than 800 lx).

For the projection system provided with the transmissive screen, the visibility of the projection image can be ensured by regulating the illuminance of the light outside a room (such as a natural light or an artificial light) and the illuminance of the projector to get close together. It is preferred that the difference (absolute value) between the former illuminance and the latter illuminance be regulated, for example, to not more than 1000 lx, preferably not more than 800 lx, and more preferably not more than 600 lx (particularly not more than 500 lx). The method to be used for regulating these illuminances may include a method of regulating the illuminance of the projector, a method of using the polarization laminate provided with the light-control layer, and other methods. Among these methods, the method of regulating the illuminance of the projector is preferred.

The illuminance of the projector side (the in-room or in-vehicle illuminance) may also be regulated by an artificial light. The visibility of both the projection image and the view of the other side of the screen (the indoor or in-vehicle view) can be ensured by regulating the illuminance of the projector side (the in-room or in-vehicle illuminance) and the illuminance of the projector to get close together. The difference (absolute value) between the former illuminance and the latter illuminance may be, for example, not more than 1000 lx, preferably not more than 800 lx, and more preferably not more than 600 lx (particularly not more than 500 lx).

### EXAMPLES

The following examples are intended to describe this invention in further detail and should by no means be interpreted as defining the scope of the invention. The materials and apparatus used in Examples are shown below. The characteristics of diffusion polarization layers obtained in Examples were evaluated according to the following methods.

[Material and Apparatus]

PEN resin: poly(ethylene naphthalate), “Teonex TN8065S” manufactured by Teijin Chemicals Ltd., viscosity at 270° C. and a shear rate of 10 sec⁻¹: 1578 Pa·s

PC resin: bisphenol A-based polycarbonate, “Medium-viscosity product Iupilon S-2000” manufactured by Mitsubishi Engineering-Plastics Corporation, viscosity-average molecular weight: 18000 to 20000, MFR: 10 g/10 min., viscosity at 270° C. and a shear rate of 10 sec⁻¹: 681 Pa·s

Absorption polarizer: iodine-series polarizing plate, “Polarizing film” manufactured by KENIS LIMITED

OCA adhesive sheet: acrylic agglutinant, “LUCIACS (registered trademark) CS9621T” manufactured by Nitro Denko Corporation

Liquid-crystal shutter: “Optical Shutter” manufactured by LC-TEC, having a liquid-crystal layer composed of a nematic liquid crystal

Neutral density filter: “ND10” manufactured by SIGMAKOKI CO., LTD.

Polarimeter (polarized-light measuring apparatus): “NDH-300A” manufactured by NIPPON DENSHOKU INDUSTRIES CO., LTD.

Scattering-angle measuring apparatus: “Variable Angle Photometer GP200” manufactured by MURAKAMI COLOR RESEARCH LABORATORY

Biaxial extruder: “PCM30” manufactured by Ikegai Ironworks Corp.

Small pressing machine: “MINI TEST PRESS 10” manufactured by Toyo Seiki Seisaku-sho, Ltd.

Tensile tester: “TENSILON UCT-5T” manufactured by ORIENTEC CO., LTD.

Short throw projector: “EB485W” manufactured by SEIKO EPSON CORPORATION

Illuminometer: “ILLUMINANCE METER T-10” manufactured by KONICA MINOLTA, INC.

LCD projector: “EB-X8” manufactured by SEIKO EPSON CORPORATION

Mobile projector: “400-PRJ018W” manufactured by SANWA SUPPLY INC.

[Evaluation of Polarized Light and Scattering Characteristics]

The stretched sheets (diffusion polarization layers) obtained in Examples and Comparative Examples were evaluated for polarized light and scattering characteristics. Specifically, by the polarimeter, the total light was measured in accordance with JIS K7361-1, and the haze (diffused light) was measured in accordance with JIS K7136. An absorption polarizer used in each of Examples and Comparative Examples was interposed between a diffusion polarization layer (stretched film) obtained in each of Examples and Comparative Examples and a light source, and a linearly polarized light alone polarized in a vertical direction was used as a light source. The total light transmittance, the diffused light transmittance, the parallel light transmittance, and the total light reflectance (calculated by subtracting the total light transmittance from 1) of the diffusion polarization layer with respect to the linearly polarized light were determined. The total light transmittance, the diffused light transmittance, and the parallel light transmittance were measured when the direction (transmission axis) perpendicular to the stretching direction of the diffusion polarization layer was allowed to agree with the transmission axis of the absorption polarizer (“transmission axis” in Table 1); the total light transmittance was measured when the stretching direction (scattering axis) of the diffusion polarization layer was allowed to agree with the transmission axis of the absorption polarizer (“scattering axis” in Table 1); and the total light reflectance was calculated.

[Measurement of Deformation Luminance]

The deformation luminance was measured by the scattering-angle measuring apparatus when a white light entered at an angle of 45° with respect to the normal line of the diffusion layer in the direction of the surface (the surface parallel with the transmission axis) perpendicular to the stretching direction.

[Aspect Ratio]

The cross section of the diffusion polarization layer was observed by a transmission electron microscope (TEM). For five long dispersed phases, the major-axis length of each phase and the minor-axis length thereof were measured, and the average aspect ratio was calculated from the average value of the major-axis length and that of the minor-axis length.

[Measurement of Illuminance]

The illuminance was measured in front of a window by the illuminometer on the supposition that the screen was placed in a room. Specifically, the outside illuminance (the illuminance through a window) was measured by the illuminometer with a sensor of the illuminometer directed toward the outside of the window. The illuminance of the room was measured by the illuminometer with the sensor directed toward the inner side of the window.

### Example 1

The PEN resin (10 parts by weight) as a resin for a dispersed phase and the PC resin (90 parts by weight) as a resin for a continuous phase were melt-kneaded and extruded at a cylinder temperature of 280° C. by the biaxial extruder and cooled to give a pellet. The resulting pellet was press-molded at 270° C. and a pressure of 10 MPa for 3 minutes by the small pressing machine to give a press sheet having a thickness of 350 μm. The resulting sheet was cut to a width of 40 mm and a length of 70 mm to give a specimen. The specimen was pre-heated at a chuck distance of 50 mm at 150° C. for 5 minutes by the tensile tester provided with a thermostatic unit, stretched to 1.5 times at a tension speed of 250 mm/min., and then heat-treated at 165° C. for 3 minutes with the specimen held by the chuck. Thereafter, the specimen was rapidly cooled to a room temperature to give a stretched film. The dispersed phase in the film had a major-axis length of 1.5 μm, a minor-axis length of 0.5 μm, and an average aspect ratio of 3.

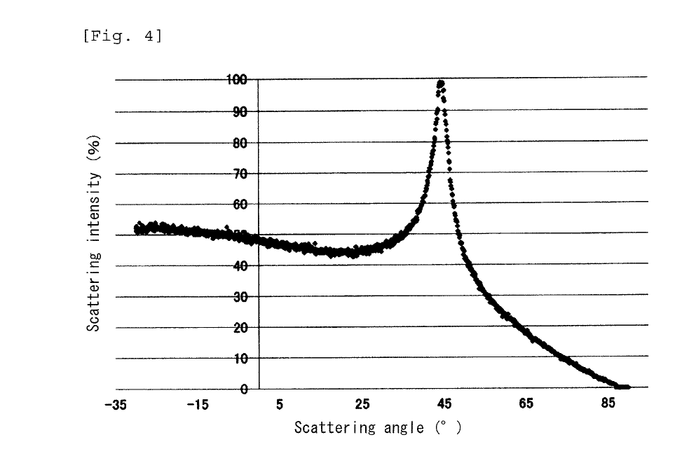

The resulting stretched film (diffusion polarization layer) was examined for the deformation luminance (ordinate: a relative value of a luminance at each scattering angle with respect to a luminance at a scattering angle of 45° abscissa: angle). The measurement results are shown in FIG. 4. As apparent from the results of shown in FIG. 4, a high luminance as shown in a wide range of angle; at the front (0°), a high luminance is shown.

The resulting stretched film was laminated to the absorption polarizer through the OCA adhesive sheet in the state the transmission axis of the stretched film was parallel with that of the polarizer, giving a polarization laminate.

### Example 2

A stretched film and a polarization laminate were produced in the same manner as Example 1 except that a press sheet having a thickness of 400 μm was produced by press molding.

### Example 3

A stretched film and a polarization laminate were produced in the same manner as Example 1 except that a press sheet having a thickness of 550 μm was produced by press molding.

### Example 4

A stretched film and a polarization laminate were produced in the same manner as Example 1 except that a press sheet having a thickness of 800 μm was produced by press molding.

### Example 5

A stretched film and a polarization laminate were produced in the same manner as Example 1 except that the ratio of the PEN resin and the PC resin was changed to the PEN resin (5 parts by weight) and the PC resin (95 parts by weight), that a press sheet having a thickness of 650 μm was produced by press molding, and that the resulting sheet was pre-heated at 165° C. for 5 minutes and then stretched to 3.0 times at a tension speed of 500 mm/min.

### Example 6

A stretched film and a polarization laminate were produced in the same manner as Example 5 except that a press sheet was stretched to 3.5 times.

### Example 7

A stretched film and a polarization laminate were produced in the same manner as Example 5 except that a press sheet was stretched to 4.0 times.

### Example 8

A stretched film and a polarization laminate were produced in the same manner as Example 5 except that a press sheet was stretched to 4.5 times.

### Example 9

A stretched film and a polarization laminate were produced in the same manner as Example 1 except that a press sheet having a thickness of 650 μm and the resulting sheet was pre-heated at 165° C. for 5 minutes and then stretched to 3.0 times at a tension speed of 500 mm/min.

### Example 10

A stretched film and a polarization laminate were produced in the same manner as Example 9 except that a press sheet was stretched to 3.5 times. The dispersed phase of the stretched film had a major-axis length of 3.2 μm, a minor-axis length of 0.4 μm, and an average aspect ratio of 8.

### Example 11

A stretched film and a polarization laminate were produced in the same manner as Example 9 except that a press sheet was stretched to 4.0 times.

### Example 12

A stretched film and a polarization laminate were produced in the same manner as Example 9 except that a press sheet was stretched to 4.5 times.

### Example 13

A stretched film and a polarization laminate were produced in the same manner as Example 1 except that the ratio of the PEN resin and the PC resin was changed to the PEN resin (20 parts by weight) and the PC resin (80 parts by weight), that a press sheet having a thickness of 650 μm was produced by press molding, and that the resulting sheet was pre-heated at 165° C. for 5 minutes and then stretched to 3.0 times at a tension speed of 500 mm/min.

### Example 14

A stretched film and a polarization laminate were produced in the same manner as Example 13 except that a press sheet was stretched to 3.5 times.

### Example 15

A stretched film and a polarization laminate were produced in the same manner as Example 13 except that a press sheet was stretched to 4.0 times.

### Example 16

A stretched film and a polarization laminate were produced in the same manner as Example 13 except that a press sheet was stretched to 4.5 times.

On the stretched films (diffusion polarization layers) obtained in Examples, Table 1 shows the blending ratio, the stretching temperature and stretching ratio, the thickness before and after stretching, and the evaluation of the polarized light and scattering characteristics.

TABLE 1

| | | | | Thickness | Thickness | Transmission axis | Transmission axis | Transmission axis | Scattering axis |
|---|---|---|---|---|---|---|---|---|---|
| | | Stretching | Stretching | before | after | total light | diffused light | parallel light | total light |
| | PC/PEN | temperature | ratio | stretching | stretching | transmittance | transmittance | transmittance | reflectance |
| unit | parts | ° C. | times | μm | μm | % | % | % | % |
| Example 1 | 90/10 | 150 | 1.5 | 350 | 310 | 84.9 | 15.2 | 69.7 | 62.4 |
| Example 2 | 90/10 | 150 | 1.5 | 400 | 325 | 88.2 | 20.5 | 67.7 | 70.3 |
| Example 3 | 90/10 | 150 | 1.5 | 550 | 480 | 85.9 | 22.5 | 63.4 | 72.4 |
| Example 4 | 90/10 | 150 | 1.5 | 800 | 680 | 79.5 | 40.2 | 39.3 | 73.0 |
| Example 5 | 95/5 | 165 | 3 | 650 | 250 | 91.0 | 21.8 | 69.2 | 65.3 |
| Example 6 | 95/5 | 165 | 3.5 | 650 | 230 | 91.9 | 19.5 | 72.4 | 65.2 |
| Example 7 | 95/5 | 165 | 4 | 650 | 220 | 91.2 | 15.5 | 75.7 | 65.3 |
| Example 8 | 95/5 | 165 | 4.5 | 650 | 200 | 92.2 | 14.4 | 77.6 | 66.1 |
| Example 9 | 90/10 | 165 | 3 | 650 | 250 | 91.0 | 25.7 | 65.3 | 76.3 |
| Example 10 | 90/10 | 165 | 3.5 | 650 | 230 | 91.9 | 18.6 | 73.3 | 76.7 |
| Example 11 | 90/10 | 165 | 4 | 650 | 220 | 91.2 | 19.0 | 72.2 | 77.8 |
| Example 12 | 90/10 | 165 | 4.5 | 650 | 200 | 92.2 | 14.0 | 78.2 | 77.2 |
| Example 13 | 80/20 | 165 | 3 | 650 | 250 | 89.4 | 36.3 | 53.1 | 83.9 |
| Example 14 | 80/20 | 165 | 3.5 | 650 | 230 | 89.8 | 23.4 | 66.5 | 83.7 |
| Example 15 | 80/20 | 165 | 4 | 650 | 220 | 91.2 | 18.5 | 72.6 | 83.6 |
| Example 16 | 80/20 | 165 | 4.5 | 650 | 200 | 91.8 | 16.0 | 75.9 | 83.4 |

As apparent from the results shown in Table 1, each of the diffusion polarization layers obtained in Examples shows a high transmission in the transmission axis and a high reflectiveness in the scattering axis.

Further, the polarization laminate obtained in Example 1 was disposed with the absorption polarization layer directed toward the light source, and the total light transmittance of the polarization laminate measured 85% by the polarimeter. Moreover, the polarization laminate obtained in Example 1 was disposed with the diffusion polarization layer directed toward the light source, the absorption polarizer was disposed between the light source and the diffusion polarization layer so that the transmission axis of the absorption polarizer was substantially parallel with the stretching direction of the diffusion polarization layer, and the total light reflectance of the polarization laminate measured 63%. The results are substantially the same as the results shown in Table 1, that is, the evaluation of the diffusion polarization layer without lamination of the absorption polarizer. The results of Table 1 (the results of the diffusion polarization layer with respect to the linearly polarized light) also show the optical characteristics of the polarization laminate.

Each of the polarization laminates obtained in Examples 1 to 16 was examined for a projection test using a short throw projector. Specifically, the polarization laminate was used as a screen (screen size: 1.5×0.9 m), the diffusion polarization layer was disposed at the projector side, and an image was projected on the screen so that a linearly polarized light was distributed at a wide range of 0 to 60° (θ in FIG. 2). The results showed that the image projected on the screen had an excellent color reproduction without luminance unevenness (mura) and that the view of the other side of the screen was also seen distinctly, in both cases where the polarization laminate was used as a reflective projector screen (wherein the vibration plane of the linearly polarized light was substantially parallel with the scattering axis of the diffusion polarization layer) and where the polarization laminate was used as a transmissive projector screen (wherein the vibration plane of the linearly polarized light was substantially parallel with the transmission axis of the diffusion polarization layer).

### Example 17

The polarization laminate obtained in Example 1 was disposed on a window with the diffusion polarization layer directed toward the light source (the inside of the room).

(Visibility in Daytime)

In the daytime in which the outside illuminance through a window was 9400 lx and the indoor illuminance of the inside of the window was 1000 lx (after the translucent screen composed of the polarization laminate was disposed, the outside illuminance was 3700 lx and the indoor illuminance was 1000 lx), an image was projected on the screen from the mobile projector at an illuminance of 1100 lx. The image (projection image) on the screen could not be seen.

(Visibility in Nighttime)

In the nighttime in which the outside illuminance was 300 lx and the indoor illuminance was 300 lx (after the translucent screen was disposed, the outside illuminance was 120 lx and the indoor illuminance was 300 lx), an image was projected on the screen from the mobile projector at an illuminance regulated to about 200 lx. The projection image on the screen and the view of the other side of the screen were able to be seen simultaneously.

### Example 18

The polarization laminate obtained in Example 1 was disposed on a window with the diffusion polarization layer light directed toward the light source (the inside of the room).

(Visibility in Daytime)

In the daytime in which the outside illuminance was 9400 lx and the indoor illuminance was 1000 lx (after the translucent screen was disposed, the outside illuminance was 3700 lx and the indoor illuminance was 1000 lx), an image was projected on the screen from the LCD projector at an illuminance of 3400 lx. The projection image on the screen and the view of the other side of the screen were able to be seen simultaneously.

In the daytime in which the outside illuminance was 17000 lx and the indoor illuminance was 1300 lx (after the translucent screen was disposed, the outside illuminance was 6800 lx and the indoor illuminance was 1300 lx), an image was projected on the screen from the LCD projector at an illuminance of 3400 lx. The projection image on the screen could not be seen.

(Visibility in Nighttime)

In the nighttime in which the outside illuminance was 300 lx and the indoor illuminance was 300 lx (after the translucent screen was disposed, the outside illuminance was 120 lx and the indoor illuminance was 300 lx), an image was projected on the screen from the mobile projector at an illuminance regulated to about 200 lx. The projection image on the screen and the view of the other side of the screen were able to be seen simultaneously.

### Example 19

The diffusion polarization layer obtained in Example 1 was laminated to the liquid-crystal shutter through the OCA adhesive sheet in the state the transmission axis of the absorption polarization layer of the liquid-crystal shutter was parallel with the transmission axis of the diffusion polarization layer, giving a polarization laminate. The resulting polarization laminate was disposed on a window with the diffusion polarization layer directed toward the light source (the inside of the room).

(Visibility in Daytime)

In the daytime in which the outside illuminance was 9400 lx and the indoor illuminance was 1000 lx, the light intensity to be decreased by the light-control layer was controlled so that the outside illuminance was regulated to 1400 lx. An image was projected on the screen from the mobile projector at an illuminance of 1100 lx. The projection image on the screen and the view of the other side of the screen were able to be seen simultaneously. Further, under the same conditions, when the indoor illuminance was regulated to 500 lx while the outside illuminance was still 1400 lx, the visibility was further improved.

In the daytime in which the outside illuminance was 17000 lx and the indoor illuminance was 1300 lx, the outside illuminance was regulated to 1400 lx by the light-control layer. An image was projected on the screen from the mobile projector at an illuminance if 1100 lx. The projection image on the screen and the view of the other side of the screen were able to be seen simultaneously. Further, under the same conditions, when the indoor illuminance was regulated to 500 lx while the outside illuminance was still 1400 lx, the visibility was further improved.

(Visibility in Nighttime)

In the nighttime in which the outside illuminance was 300 lx and the indoor illuminance was 300 lx, the light intensity to be decreased by the light-control layer was controlled (by fully opening the shutter) so that the outside illuminance was regulated to 120 lx. An image was projected on the screen from the mobile projector at an illuminance regulated to about 200 lx. The projection image on the screen and the view of the other side of the screen were able to be seen simultaneously. Further, under the same conditions, when the indoor illuminance was regulated to 150 lx by decreasing the number of fluorescent lamps lighted while the outside illuminance was still 120 lx, the visibility was further improved. In contrast, when the indoor illuminance was increased to 900 lx by increasing the number of fluorescent lamps lighted, the visibility of the view of the other side of the screen was reduced.

For Example 19, although the mobile projector used consumed less electricity compared with the projector used in Example 18, the visibility in the daytime conditions was excellent due to the liquid-crystal shutter incorporated.

### Example 20

The polarization laminate obtained in Example 1 was laminated to the neutral density filter through the OCA adhesive sheet so that the absorption polarization layer of the polarization laminate was put into contact with the neutral density filter, giving a polarization laminate. The resulting polarization laminate was disposed on a window with the diffusion polarization layer directed toward the light source (the inside of the room).

(Visibility in Daytime)

In the daytime in which the outside illuminance was 9400 lx and the indoor illuminance was 1000 lx, the outside illuminance was regulated to 1000 lx by the light-control layer. An image was projected on the screen from the mobile projector at an illuminance of 1100 lx. The projection image on the screen and the view of the other side of the screen were able to be seen simultaneously.

In the daytime in which the outside illuminance was 17000 lx and the indoor illuminance was 1300 lx, the outside illuminance was regulated to 1700 lx by the light-control layer. An image was projected on the screen from the mobile projector at an illuminance of 1100 lx. The projection image on the screen and the view of the other side of the screen were able to be seen simultaneously.

(Visibility in Nighttime)

In the nighttime in which the outside illuminance was 300 lx and the indoor illuminance was 300 lx, the outside illuminance was regulated to about 30 lx by the light-control layer. An image was projected on the screen from the mobile projector at an illuminance regulated to about 200 lx. However, the view of the other side of the screen was able to be seen.

### INDUSTRIAL APPLICABILITY

The polarization laminate of the present invention is utilizable as a translucent screen for displaying a project ion image from a variety of projectors, for example, an OHP (overhead projector), a slide projector, a CRT (cathode-ray tube)-system projector (such as a CRT projector), a light valve projector [such as a liquid-crystal projector, a digital-light-processing (DLP) projector, a liquid-crystal-on-silicon (LCOS) projector, or a grating-light-valve (GLP) projector]. For example, the polarization laminate is utilizable for a window display, a head up display (HUD), and a head mounted display (HMD). In particular, even in a case where an emission light from the projector enters a screen at a wide angle of incidence, the visibility of the image is high. Thus, the screen prevents the reflection therein of a light source of the projector and allows the projection of a distinct image even in a case where the screen is a short throw projector screen having a large angle of incidence (such as HUD or HMD) or a transmissive screen. Accordingly, the polarization laminate is particularly useful for a window display, for example, a digital signage, an augmented reality application, and a window display of a vehicle (such as an automobile, a train, or a bus).

1. A transparent polarization laminate as a member or element of a see-through projector screen for displaying a projection image from a projector, wherein
the polarization laminate comprises a diffusion polarization layer and an absorption polarization layer,
the diffusion polarization layer has a transmission axis substantially parallel with a transmission axis of the absorption polarization layer, and
the diffusion polarization layer comprises a continuous phase comprising a first transparent thermoplastic resin and a dispersed phase comprising a second transparent thermoplastic resin and having a refractive index different from that of the continuous phase.

2. A polarization laminate according to claim 1, wherein the diffusion polarization layer is capable of polarizing an incident natural light to give first and second linearly polarized light components, and the diffusion polarization layer diffuses the first light component more than the second light component and transmits the first light component less than the second light component.

3. A polarization laminate according to claim 2, which has a total light transmittance of not less than 80% and a diffused light transmittance of not more than 25% when a linearly polarized light substantially parallel with the transmission axis enters from the absorption polarization layer side toward the diffusion polarization layer.

4. A polarization laminate according to claim 2, which has a total light reflectance of not less than 60% when a linearly polarized light substantially perpendicular to the transmission axis enters from the absorption polarization layer side toward the diffusion polarization layer.

5. A polarization laminate according to claim 1, wherein the diffusion polarization layer comprises a stretched sheet, the continuous phase has an in-plane birefringence of less than 0.05, the dispersed phase has an in-plane birefringence of not less than 0.05, and a difference in refractive index for linearly polarized light between the continuous phase and the dispersed phase in a stretching direction is different from that in a direction perpendicular to the stretching direction.

6. A polarization laminate according to claim 5, wherein the difference in refractive index between the continuous phase and the dispersed phase in the stretching direction has an absolute value of 0.1 to 0.3, and the difference in refractive index between the continuous phase and the dispersed phase in the direction perpendicular to the stretching direction has an absolute value of not more than 0.1.

7. A polarization laminate according to claim 1, wherein the continuous phase comprises a polycarbonate, and the dispersed phase comprises a poly(alkylene naphthalate)-series resin.

8. A polarization laminate according to claim 1, wherein the dispersed phase has an elongated form having an average aspect ratio of 2 to 200, is substantially uniformly dispersed in the continuous phase, and has a major-axis direction oriented to a direction substantially parallel with a surface direction of the laminate.

9. A polarization laminate according to claim 1, wherein the absorption polarization layer comprises a stretched sheet of an iodine-containing vinyl alcohol-series resin.

10. A polarization laminate according to claim 1, wherein the diffusion polarization layer and the absorption polarization layer are laminated through a transparent adhesive layer.

11. A polarization laminate according to claim 1, which further comprises a light-control layer capable of emitting a light at an emitted light intensity less than an incident light intensity, wherein the absorption polarization layer is interposed between the light-control layer and the diffusion polarization layer.

12. A polarization laminate according to claim 11, wherein the light-control layer is capable of regulating a decrease in the emitted light intensity.

13. A polarization laminate according to claim 11, which is used for a reflective screen.

14. A see-through projector screen comprising a polarization laminate recited in claim 1.

15. A see-through projector screen according to claim 14, which is a reflective or transmissive screen on which an image from a projector is projected from the diffusion polarization layer side.

16. A see-through projector screen according to claim 14, which is a short throw projector screen.

17. A projection system comprising a see-through projector screen recited in claim 14 and a projector.

18. A projection system according to claim 17, wherein the diffusion polarization layer comprises a uniaxially stretched sheet and is disposed at a projector side, and the projector is so disposed that a light projected from the projector enters at an incident angle of more than 0° with respect to a surface direction perpendicular to a stretching direction of the stretched sheet.

19. A projection system according to claim 17, wherein the projector is capable of emitting a linearly polarized light having a vibration plane substantially perpendicular to a transmission axis of the diffusion polarization layer, and the see-through projector screen is a reflective screen.

20. A projection system according to claim 17, wherein the projector is capable of emitting a linearly polarized light having a vibration plane substantially parallel with a transmission axis of the diffusion polarization layer, and the see-through projector screen is a transmissive screen.

21. (canceled)
